(19) United States
(12) Patent Application Publication
(10) Pub. No.: US 2004/0267561 A1
(43) Pub. Date: Dec. 30, 2004

(54) System, method and apparatus for an online sports auction

(75) Inventors: Alexander B. Meshkin, Huntersville, NC (US); Cameron H. Tousi, Rockville, MD (US)

Correspondence Address: INTELLECTUAL PROPERTY SOLUTIONS, INCORPORATED, 5717 COLFAX AVENUE, ALEXANDRIA, VA, 22311, US

(73) Assignee: Bang, LLC

(21) Appl. No.: 10/831,345

(22) Filed: Apr. 26, 2004

Related U.S. Application Data
(63) Continuation-in-part of application No. 10/305,393, filed on Nov. 27, 2002.
(63) Continuation-in-part of application No. 10/681,331, filed on Oct. 9, 2003.
(60) Provisional application No. 60/416,905, filed on Oct. 9, 2002.

(51) Int. Cl. G06F 17/60; G06F 15/173

(52) U.S. Cl. 705/1; 709/224

(57) ABSTRACT

An web-based online sports system for information sharing, collaboration and vending of buying and selling opportunities between sellers and purchasers related to sports and entertainment. Applications servers (ASs) and database servers (DSs) are provided to implement the features and functions of permitting purchasers to investigate buying and selling opportunities by set factors. For motorsports, an online auction market for auto-parts permits racing company buyers to auction used auto-parts to interested sellers. Another online auction market is created for sponsorship buying and selling opportunities between car companies desiring to sell on-the-vehicle sponsorship and purchasers willing to purchase the sponsorship. Online sellers investigate teams using metrics, including identity of team, identity of driver, size of sponsorship, location of sponsorship, identity of racing series, identity of racing event, community and external reputation. Online buyers investigate teams using metrics, including the name and addresses of the company, individual or entity, and their company affiliates, credit ratings, industry area, payment practices, community and external reputation. The AS/DSs also facilitate how goods/services are provisioned, legal engagement between parties, online communications between parties (through real-time chats, video, message threads), providing of standard or alternative billing, banking of payments between parties, and management of the results of tasks/services.

### RELATED APPLICATION

This Application is a Continuation-In-Part of U.S. patent application Ser. No. 10/681,331, Filed Oct. 9, 2003, Entitled “System, Method and Apparatus for an Integrated Marketing Vehicle Platform,” which Claims Priority of PROVISIONAL APPLICATION No. 60/681,331, Filed Oct. 9, 2002, and a Continuation-In-Part of U.S. patent application Ser. No. 10/305,393, Filed Nov. 27, 2002, Entitled “System, Method and Computer Program Product for a Law Community Service System.”

### BACKGROUND OF THE INVENTION

Portions of the disclosure of this patent document may contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### FIELD OF THE INVENTION

The present invention relates generally to the field of marketing, and more particularly, to a system and method for targeted and interactive marketing across multiple platforms in online, wireline, and wireless environments.

### RELATED ART

Revenue generating opportunities for entertainment generally and the sports industry, in particular, have tended to follow traditional methods, with relatively few advances to increase market share and generate greater profit margins. Much of modern sports are tied to the dynamics of selling sponsorship opportunities in exchange for promoting, advertising and branding willing corporations. Yet, newer, more complex marketing techniques making use of recent technological advances are quite rarely used. Nor are methods advanced to promote, market, barter or sell other goods or services available to sports teams and industry players.

With respect to the world of corporate promotions and marketing, sports is but one of many facets of corporate branding and advertisement dynamics. For many years, companies have tried to brand their products, satisfy existing consumers, and reach potential new consumers through traditional means. The evolution has been linear when less creative, and sometimes non-linear, when more creative, as advertising has gone from print forms like newspapers, magazines, brochures, newsletters, press releases and billboards, to event-related activities, like sponsorships, seminars, point-of-sale and promotional programs, to broadcast media, like radio, television, cable and recently satellite cable.

The last decade has seen the rise of advertising that is more targeted and tailored to individual consumers, with new forms of previously so-called direct advertising. New endeavors have sought to interact directly with consumers through pull campaigns and push campaigns, and make advertising more measurable to bring advertisers specific consumer data mining bearing on consumer buying habits, trending and predicting future habits. Advances in technology outlets combined with marketing ingenuity have expanded the old direct mail marketing campaigns into new branches, including telemarketing, point-of-sale campaigns, computer platforms, and most recently distribution and measurement through telecommunications networks.

With respect to the latter, perhaps the greatest platform for the new world of marketing has been the same as the greatest platform for information exchange in the last decade, namely the Internet. Through such avenues as branded websites, banner ads, pop-up ads, targeted e-mails, portal sponsorships, to name a few examples, advertisers have been able to hone in on target audiences. Through defined metrics and innovative semantics, like served impressions, click-through rate (CTR), cost per action (CPA), cost per click (CPC), cost per sale (CPS), and cost per thousand (CPM), to name a few, advertisers have been able to measure the results of targeted ads and objectively set fees for performance results obtained. Along with these new advances, and because of the increasingly cosmopolitan nature of business, geopolitics, and integrated telecommunications networks, so too has advertising become increasingly global in nature.

However, despite the aforementioned advances for branding, the sports teams, or agents thereof, must still be engaged in the process of selling sponsorship and advertising opportunities, branded merchandise, or other goods and services, to maintain revenue or expand profit. For example, in motorsports, in particular for the National Association for Stock Car Auto Racing (“NASCAR”), the car companies must engage in the activity of selling corporations desiring branding on-the-vehicle sponsorship during races, or trademarked merchandise bearing the logos of teams, drivers, and corporation sponsors. For a team to be engaged in the process of marketing its sponsorship to corporate consumers and individuals can be an onerous, often time-consuming task. Such teams, and other players in the sports arena, also have need of additional bartering opportunities to promote their own growth and increase profit margins to their owners. What is needed is a way of enabling sports industry teams and other principals engaged in the sporting industry to have to opportunity to increase their profit making capability, through sale of sponsorship, merchandise, or other goods and services.

### SUMMARY OF THE INVENTION

Advertisers have traditionally been unable to properly gather and use consumer information, to provide for cross promotion across various platforms, to elicit accurate consumer data and engage consumers, or to make the consumer's experience interactive and dynamic, to benefit both advertiser and consumer in a meaningful and measurable manner. The parent of this application, incorporated herein by reference in its entirety, U.S. patent application Ser. No. 10/681,331, filed Oct. 9, 2003, and entitled “System, Method and Apparatus for an Integrated Marketing Vehicle Platform” solves this long-felt problem in the art.

The Integrated Marketing Vehicle Platform (IMVP) permits advertisers, ad agencies, broadcasters, sponsors, and any other entities desiring to manage and modify consumer behavior, called “brand entities,” to (i) properly gather and use consumer information, from demographics, to psychographics, to previous purchasing habits, and based on the desires of brand entities, gage consumer demands, on everything from current buying habits to affiliations with hobbies and athletic activities; (ii) to cross promote their products and trademarks across various types of platforms, including technologies, networks, protocols, interest groups, to name a few; (iii) to elicit real-time consumer responses and interest in a way that is measurable, dynamic, and interactive; and (iv) to enhance consumer participation and experience, and effect long term product sales, through loyalty, redemption and incentive programs.

IMVP also provides a dynamically accessible and programmable marketing tool, capable of collecting and assessing user data from existing and potential consumers in real-time, across multiple platforms. Brand entities could now use the tool to promote short term sales, promote long term behavior, establish rapport and brand recognition with their consumer base and promote consumer branding affiliations.

One extremely effective use for IMVP is in traditional sports related marketing where brand entities, such as corporations or individuals, sponsor events or athletes, in exchange for the right to advertise. Motorsports is one area where sponsorship has worked effectively.

For example, the National Association for Stock Car Auto Racing (NASCAR™, hereinafter NASCAR) is the preeminent racing organization in the United States. Three main racing series of NASCAR include the NASCAR Craftsman™ Truck Series, NASCAR Busch™ Series, and NASCAR Nextel™ Cup Series.

Each of the races of a Series, trucks or cars, as the case may be, attempt to qualify for and enter such races, by making use of the latest advances in automotive design, fabrication, and testing, and hire some of the world's top drivers. Car companies are funded primarily by brand entities, such as corporations or individuals, who pay for advertising of the racing related activities.

Traditionally, the advertising appears on the racing vehicle itself, on driver's uniforms, and on haulers, trailers and other vehicles owned by the team. As motorsports, and particularly the influence of NASCAR has grown, so has media advertising, through such outlets as traditional radio, television, cable, and more recently satellite television and radio. So has grown advertising through the aforementioned advances on the Internet.

Exemplary environments, among the numerous environments in which IMVP are used, include broadcasters desiring to supplement and promote branding for their own advertiser customers, and corporate sponsors of NASCAR events desiring to integrate and cross-promote their traditional racing vehicle sponsorships with real-time wireless and online promotions.

The IMVP cross-platform solution is particularly relevant in NASCAR racing, enabling brand entities to access rapidly expanded consumer intelligence in different marketing endeavors, and permitting brand entities to measure, modify and manage their marketing messages, to permit them to measure and estimate future consumer behavior.

As alluded to, across all sports, the process of acquiring sponsorship revenue in exchange for advertising requires great expertise and access to capital, in time, human capital and financial capital. The parent of this application, incorporated herein by reference in its entirety, U.S. patent application Ser. No. 10/305,393, filed Nov. 27, 2002, and entitled “System, Method and Computer Program Product for a Law Community Service System,” provides an extremely complete method for individuals, corporations, or other entities desiring to purchase goods/services to purchase the same from individuals, corporations, or other entities desiring to provide or sell them, through auction and non-auction based systems.

In one or more embodiments, the systems and processes of the aforementioned are applied to the dynamic world of sports, to promote and facilitate the opportunities for sports teams, corporations, and any other interested parties the opportunity to engage in the activity of purchase and sale of sports related goods and services.

For example, in one or more embodiments, the online marketplace community known as eBay™ is used as the marketplace for goods and services, and the buyers and sellers are eBay™ users. In one or more of these embodiments, the services traded are sponsorship opportunities in sports and/or entertainment, sold from willing buyers to willing sellers through one or more auctions, or at fixed prices, on eBay.™ As one example, on-the-vehicle sponsorship in motorsports racing events, in particular NASCAR series racing events, are auctioned or sold at fixed prices on eBay.™

In one or more of these embodiments, the goods traded on eBay™ are sports or entertainment equipment, sold from willing buyers to willing sellers through one or more auctions, or at fixed prices, on eBay.™ As one example, used automotive parts and equipment, in particular from NASCAR racing teams, are auctioned or sold at fixed prices on eBay.™

However, the present invention is not limited to eBay™ auctions and, as described herein, is used with respect to any online system or auction. In fact, in one or more embodiments, non-auction based websites are disclosed, employing modern and conceived technologies and business arrangements.

In one or more embodiments, a system, method and apparatus are provided for a web-based online sports auction for information sharing, collaboration and vending of sponsorship buying and selling opportunities between sponsorship sellers and sponsorship purchasers. The disclosed embodiments can be used for any type of sports or entertainment activity.

In one or more embodiments, Applications servers (ASs) and database servers (DSs) are provided for the features and functions of permitting purchasers to investigate buying opportunities by set factors. These factors can include the identity of a team, identity of its driver, the size of the sponsorship, the location of sponsorship, the identity of racing series, the identity of the racing event, to name a few examples.

In one or more embodiments, additional features and functions are provided, including permitting sponsorship sellers to investigate sponsorship buyers by set factors, such as the name and addresses of the company, individual or entity, and their company affiliates, credit ratings, industry area, payment practices, community and external reputation.

In one or more embodiments, sponsorship purchasers and other brand entities can also investigate the potential benefits of sponsorship through use of IMVP metrics relating to targeted consumers, including demographics, psychographics, previous purchasing habits, and based on the desires of the brand entities.

In one or more embodiments, purchasing/selling opportunities are facilitated by calculating opportunities provisioning, legal engagement between parties, online communications between parties (through real-time chats, video, message threads), providing of standard or alternative fees and billing arrangements, banking of payments between parties, and management of the results of tasks/services.

Further features and advantages of the invention, as well as the structure and operation of various embodiments of the invention, are described in detail below with reference to the accompanying drawings.

### BRIEF DESCRIPTION OF THE DRAWINGS

The foregoing and other features and advantages of the invention will be apparent from the following, more particular description of a preferred embodiment of the invention, as illustrated in the accompanying drawings wherein like reference numbers generally indicate identical, functionally similar, and/or structurally similar elements. The left most digits in the corresponding reference number indicate the drawing in which an element first appears.

FIG. 1 illustrates an exemplary computer and telecommunications network environment;

FIG. 2 illustrates an exemplary computer system environment;

FIG. 3 illustrates an exemplary client-server environment;

FIG. 4 illustrates a detailed exemplary client-server environment;

FIG. 5 illustrates en exemplary modular structure for application servers and database servers used in implementing the present invention;

FIGS. 6A, 6B and 6C respectively illustrate the exemplary first, second and third portions of a web page for registration of sellers;

FIG. 6D illustrates en exemplary manner in which a purchaser's review of a user agreement and a privacy agreement can be verified online;

FIG. 6E illustrates an exemplary manner in which a purchaser can provide fee information upon online registration;

FIG. 6F illustrates an exemplary seller index and numerous exemplary fields for seller user entities;

FIG. 6G illustrates an exemplary purchaser index and numerous exemplary fields for purchaser user entities;

FIG. 7 illustrates such an exemplary industry area database for purchaser user entities, which can be illustrated to a seller user entity;

FIG. 8 illustrates Online Sports system listings for the specific embodiment of purchase and selling of sponsorship positions between sponsorship seller user entities and sponsorship purchaser user entities;

FIG. 9 illustrates an exemplary manner in which a purchaser user entity and a seller user entity can negotiate the terms of an agreement;

FIG. 10A illustrates an exemplary online discussion thread for posting to the Online Sports system;

FIG. 10B illustrates exemplary contents of message threads posted to the Online Sports system;

FIG. 10C illustrates an exemplary online chat session for the Online Sports system;

FIG. 11 illustrates exemplary online auctions for goods/services between purchaser user entities and seller user entities;

FIG. 12A illustrates an exemplary manner in which traditional bill presentment and payment and electronic bill presentment and payment can be employed on the Online Sports system;

FIG. 12B illustrates an exemplary manner in which a consolidation and aggregation service can be used on the Online Sports system; and

FIG. 13 is an exemplary conceptual diagram illustrating an object oriented or multilevel view of progress management features provided by the Online Sports system.

### DETAILED DESCRIPTION OF AN EXEMPLARY EMBODIMENT OF THE PRESENT INVENTION

### Table of Contents

I. EXEMPLARY EMBODIMENT

II. NODE-NODE ENVIRONMENT

III. MACHINE INSTRUCTIONS ENVIRONMENT

IV. COMPUTER HARDWARE ENVIRONMENT

V. CLIENT-SERVER ENVIRONMENT

VI. INTERNET AND WORLD WIDE WEB ENVIRONMENT

A. Introduction

B. Displaying Information and Navigating on the Web

VII. ONLINE SPORTS AUCTION

A. Overview

B. Registration

C. Investigations of Sellers

D. Investigations of Clients

E. Goods/Services Listings

F. Online Agreement

G. Online Communication

H. Fee Arrangements

I. Banking

J. Progress Management

VIII. CONCLUSION

I. Exemplary Embodiment

While specific exemplary examples, environments and embodiments are discussed below, it should be understood that this is done for illustration purposes only. A person skilled in the relevant art will recognize that other components and configurations can be used without parting from the spirit and scope of the invention. In fact, after reading the following description, it will become apparent to a person skilled in the relevant art how to implement the invention in alternative examples, environments and embodiments.

II. Node-Node Environment

In one or more embodiments, the invention is practiced in the environment of a computer network or networks. The network can include a private network, or a public network (for example the Internet, as described below), or a combination of both. The network includes hardware, software, or a combination of both.

As skilled persons will recognize, from a high-level, telecommunications-oriented view, the network can be described as a set of hardware nodes interconnected by a communications facility, with one or more processes (hardware, software, or a combination thereof) functioning at each such node. The processes can inter-communicate and exchange information with one another via communication pathways between them called interprocess communication pathways.

On these pathways, appropriate communications protocols are used. Skilled persons will recognize that the distinction between hardware and software is not always easily defined, with the same or similar functions capable of being preformed with use of either. This is especially true for functionality associated with the communications between processes.

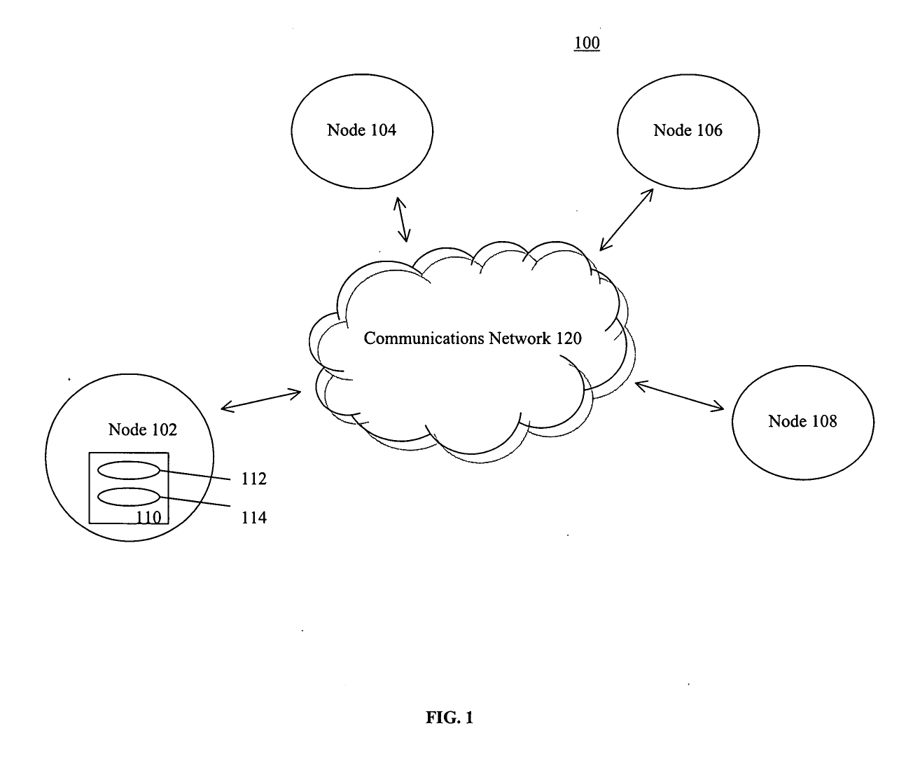

FIG. 1 illustrates an exemplary computer and telecommunications network environment 100. Environment 100 includes nodes 102-108, which include hardware, software, or a combination of hardware and software. Nodes 102-108 are interconnected via communications network 120. Each node 102-108 includes one or more processes 112, 114, executable by processors 110 incorporated into the nodes. It is possible that a single process 112 can be run by multiple processors 110, or that multiple processes 112, 114 can be run by a single processor 110. Additionally, each of nodes 102-108 can provide an interface point between network 100 and the outside world, and can incorporate a collection of subnetworks.

Persons of skill in the art will appreciate that the “software” processes 112, 114 include software and/or hardware entities that perform work over time, such as tasks, threads, and intelligent agents. Also, each process 112 can refer to multiple processes, for carrying out instructions in sequence or in parallel, continuously or intermittently.

In one embodiment, the processes 112, 114 communicate with one another through interprocess communication pathways (not labeled) supporting communication through any communications protocol. The pathways can function in sequence or in parallel, continuously or intermittently. The pathways can use any of the communications standards, protocols or technologies, described below with respect to communications network 120, in addition to standard parallel instruction sets used by many computers.

Nodes 102-108 include any entities capable of performing processing functions. Examples of nodes 102-108 that can be used with the present invention include computers (such as personal computers, workstations, servers, or mainframes), handheld wireless devices and wireline devices (such as personal digital assistants (PDAs), modern cell phones with processing capability, wireless e-mail devices including BlackBerry™ devices), document processing devices (such as scanners, printers, facsimile machines, or multifunction document machines), or complex entities (such as local-area networks or wide area networks) to which are connected a collection of processors, as described. For example, in the context of the present invention, a node itself can be a wide-area network (WAN), a local-area network (LAN), a private network (such as a Virtual Private Network (VPN)), or collection of networks.

Communications between nodes 102-108 is made possible by communications network 120. A node 102-108 can be connected either continuously or intermittently with communications network 120. As an example, in the context of the present invention, communications network 108 can be a digital communications infrastructure providing adequate bandwidth and information security.

Communications network 120 can include wireline communications capability, wireless communications capability, or a combination of both, at any frequencies, using any type of standard, protocol or technology. In addition, in the present invention, communications network 120 can be a private network (for example, a VPN) or a public network (for example, the Internet).

A non-inclusive list of exemplary wireless protocols and technologies used by communications network 120 includes BlueTooth™, general packet radio service (GPRS), cellular digital packet data (CDPD), mobile solutions platform (MSP), multimedia messaging (MMS), wireless application protocol (WAP), code division multiple access (CDMA), short message service (SMS), wireless markup language (WML), handheld device markup language (HDML), binary runtime environment for wireless (BREW), radio access network (RAN), and packet switched core networks (PS-CN).

Also included are various generation wireless technologies, as set forth in Table 1. It should be noted that the definitions provided therein and the other tables herein are provided for convenience of understanding the concepts of the present invention, and not by way of limiting the features and functions of the specification.

A exemplary non-inclusive list of primarily wireline protocols and technologies used by communications network 120 includes asynchronous transfer mode (ATM), enhanced interior gateway routing protocol (EIGRP), frame relay (FR), high-level data link control (HDLC), Internet control message protocol (ICMP), interior gateway routing protocol (IGRP), internetwork packet exchange (IPX), ISDN, point-to-point protocol (PPP), transmission control protocol/internet protocol (TCP/IP), routing information protocol (RIP) and user datagram protocol (UDP). As skilled persons will recognize, any other known or anticipated wireless or wireline protocols and technologies can be used.

TABLE 1

| GENERATION | DESCRIPTION |
|---|---|
| 1G | 1G refers to the first generation wide area wireless (WWAN) |
| | communications systems, dated in the 1970s and 1980s. These devices |
| | are analog, designed for voice transfer and circuit-switched, and include |
| | AMPS, NMT and TACS. |
| 2G | 2G refers to second generation WWAN communications, dated in the |
| | 1990s, characterized as digital, capable of voice and data transfer, and |
| | include HSCSD, GSM, CDMA IS-95-A and D-AMPS (TDMA/IS-136). |
| 2.5G | 2.5G refers to the generation of WWAN communications between 2G |
| | and 3G. |
| 3G | 3G refers to third generation WWAN communications systems recently |
| | coming into existence, characterized by data rates of 144 Kbps to over 2 |
| | Mbps (high speed), being packet-switched, and permitting multimedia |
| | content, including GPRS, 1xRTT, EDGE, HDR, W-CDMA. |
| 4G | 4G refers to fourth generation WWAN communications systems, |
| | expected to come in the years 2006-2010, characterized by very high- |
| | speed (over 20 Mbps) data rates, permitting high-resolution for video. |

As noted, each node 102-108 includes one or more processes 112, 114, executable by processors 110 incorporated into the nodes. In a number of embodiments, the set of processes 112, 114, separately or individually, can represent entities in the real world, defined by the purpose for which the invention is used.

Furthermore, the processes 112, 114 and processors 110 need not be located at the same physical locations. In other words, each processor 112, 114 can be executed at one or more geographically distant processor 110, over for example, a LAN or WAN connection.

Persons of skill in the art will appreciate a great range of possibilities for practicing the invention using different networking hardware and software configurations.

III. Machine Instructions Environment

In one or more embodiments, the steps of the present invention are embodied in machine-executable instructions. The instructions can be used to cause a processing device, for example a general-purpose or special-purpose processor, which is programmed with the instructions, to perform the steps of the present invention.

Alternatively, the steps of the present invention can be performed by specific hardware components that contain hardwired logic for performing the steps, or by any combination of programmed computer components and custom hardware components.

For example, the present invention can be provided as a computer program product. In this environment, the invention can include a machine-readable medium having instructions stored on it. The instructions can be used to program any processor (or other electronic devices) to perform a process according to the present invention.

The machine-readable medium can include, for example, floppy diskettes, optical disks, CD-ROMs, and magneto-optical disks, ROMs, RAMs, EPROMs, EEPROMs, magnet or optical cards, or other type of media/machine-readable medium suitable for storing electronic instructions, but is not limited to the foregoing.

In addition, the present invention can also be downloaded as a computer program product. Here, the program can be transferred from a remote computer (e.g., a server) to a requesting computer (e.g., a client) by way of data signals embodied in a carrier wave or other propagation medium via a communication link (e.g., a modem or network connection).

IV. Computer Hardware Environment

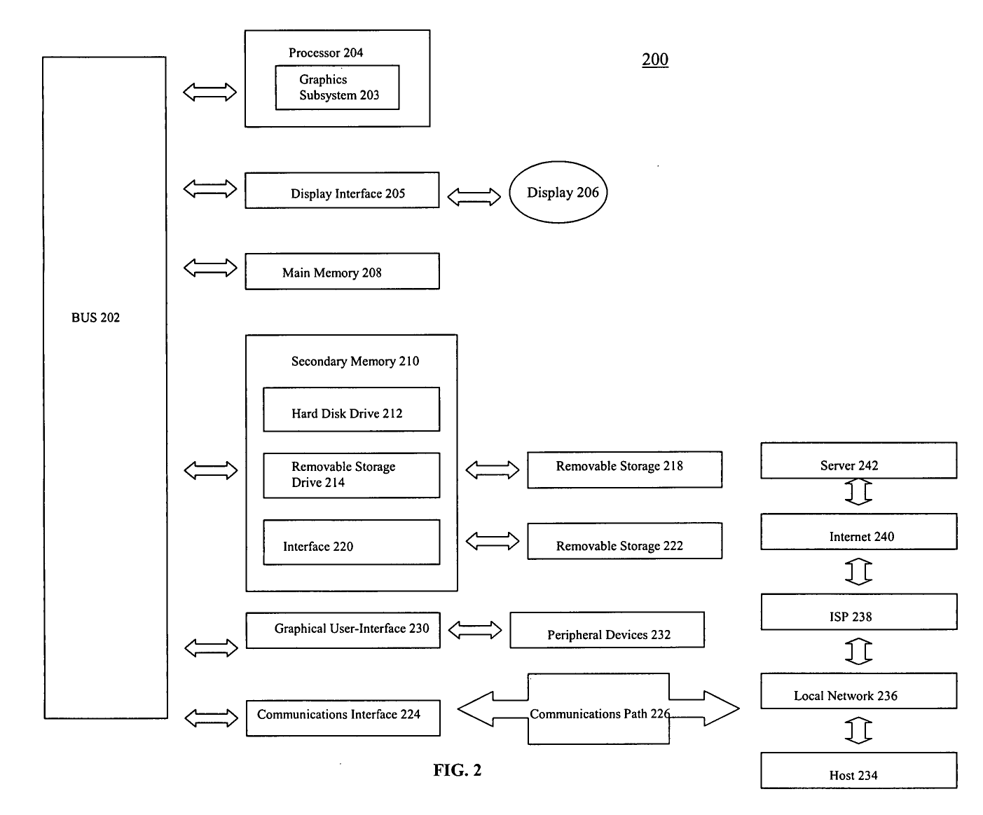

In one embodiment, illustrated in FIG. 2, node 102 is a computer system 200. Computer system 200 includes bus 202, processor 204 (including graphics subsystem 203), display interface 205, display 206, main memory 208, secondary memory 210 (including hard disk drive 212, removable storage drive 214, and interface 220), removable storage units 218, 222, graphical user-interface 230, peripheral devices 232 and communications interface 224. Computer system 200 is also connected via communications path 226 to external networks. Various embodiments are described in terms of this example computer system. After reading this description, it will be apparent to a person skilled in the relevant art how to implement the invention using other computer systems and/or computer architectures.

Processor 204, which can represent multiple processors, is connected to a communications bus 202. Graphics subsystem 203, shown as associated with processor 204, can be implemented as one or more processor chips. In fact, graphics subsystem 203 can be included as part of processor 204 as shown in FIG. 2 or as a separate graphics engine or processor. Graphics data is output from the graphics subsystem 203 to the bus 202.

Display interface 205 forwards graphics data from the bus 202 for display on the display unit 206. This graphics data includes graphics data for the screen displays described herein.

Main memory 208 can be a random access memory (RAM), and can also include a secondary memory 210. In the present invention the secondary memory 210 can include, for example, a hard disk drive 212 and/or a removable storage drive 214, representing a floppy disk drive, a magnetic tape drive, an optical disk drive, etc. The removable storage drive 214 reads from and/or writes to a removable storage unit 218 in a well known manner. Removable storage unit 218 represents a floppy disk, magnetic tape, optical disk, etc., which is read by and written to by removable storage drive 214. As will be appreciated, the removable storage unit 218 includes a computer usable storage medium having stored therein computer software and/or data.

In alternative embodiments, secondary memory 210 can include other similar means for allowing computer programs or other instructions to be loaded into computer system 200. Such means can include, for example, a removable storage unit 222 and an interface 220. In the present invention examples can also include a program cartridge and cartridge interface (such as that found in video game devices), a removable memory chip (such as an EPROM, or PROM) and associated socket, and other removable storage units 222 and interfaces 220 which allow software and data to be transferred from the removable storage unit 222 to computer system 200.

Graphical user interface module 230 transfers user inputs from peripheral devices 232 to bus 206. These peripheral devices 232 can be a mouse, keyboard, touch screen, microphone, joystick, stylus, light pen, or any other type of peripheral unit.

Computer system 200 can also include a communications interface 224. Communications interface 224 allows software and data to be transferred between computer system 200 and external devices via communications path 226. Examples of communications interface 224 that can be used with the present invention include a standard or cable modem, a DSL connection, a network interface (such as an Ethernet card), a communications port, a LAN connection, a WAN connection, etc. Computer programs and data transferred via communications interface 224 are in the form of signals which can be electronic, electromagnetic, optical or other signals capable of being received by communications interface 224, via communications path 226. Note that communications interface 224 provides a means by which computer system 200 can interface to a network such as the Internet.

The present invention can be implemented using computer programs (i.e., “software,” or “computer control logic”) running on Processor 204. The software can be originally stored as a “computer program product” on removable storage device 218 or hard disk drive 212. Therefore, computer program product refers to means for providing software to computer system 200.

Computer programs can also be stored in main memory 208 and/or secondary memory 210. Computer programs can also be received via communications interface 224. Such computer programs, when executed, enable the computer system 200 to perform the features of the present invention as discussed herein. In particular, the computer programs, when executed, enable the processor 204 to perform the features of the present invention.

In another embodiment, the invention is implemented primarily in firmware and/or hardware using, for example, hardware components such as application specific integrated circuits (ASICs). Implementation of a hardware state machine so as to perform the functions described herein will be apparent to persons skilled in the relevant arts.

In the example environment shown, communication interface 224 provides a two-way data communication coupling via a communications path 226 to a local network 236. For example, if communication interface 224 is an integrated services digital network (ISDN) card or a modem, communication interface 224 provides a data communication connection to the corresponding type of telephone line, which comprises part of communications path 226. If communication interface 224 is a local area network (LAN) card, or connects to a LAN 236, then it can provide a data communication connection via communications path 226 to a compatible LAN. Wireless links are also possible. In any such implementation, communication interface 224 sends and receives electrical, electromagnetic or optical signals which carry digital data streams representing various types of information.

Communications path 226 typically provides data communication through one or more networks to other data devices. For example, in the present invention communications path 226 can provide a connection through local network 236 to host computer 234 or to data equipment operated by an Internet Sponsorship provider (ISP) 238. In turn, ISP 238 provides data communication services through the worldwide packet data communication network now commonly called the “Internet” 240, described in detail in other embodiments.

Local network 236 and Internet 240 both use electrical, electromagnetic or optical signals that carry digital data streams. The signals through the various networks and the signals on communications path 226 and through communication interface 224, which carry the digital data to and from computer 200, are exemplary forms of carrier waves transporting the information.

Computer system 200 can send messages and receive data, as well as computer programs, through the network or networks, communications path 226, and communication interface 224. If the network used is the Internet, server 242 can transmit a requested code for an application program through Internet 240, ISP 238, local network 236 and communications path 226. Examples of such applications are the application programs run by application servers and database servers, as described in detail below.

V. Client-Server Environment

In one embodiment, the aforementioned nodes 102-108, processors 110, and processes 112, 114 running on the processors, are described by virtue of their functions with respect to information retrieval within a network.

Specifically, a node that requests information is termed a “client” and a node that transmits the requested information is termed a “server.” A node can have the dual roles of serving as both a client as well as a server.

The processes running on the clients are termed client applications, and the processes running on a server are termed server applications. Information exchange occurs between the server application providing the information or services, and the client application receiving the provided information and services.

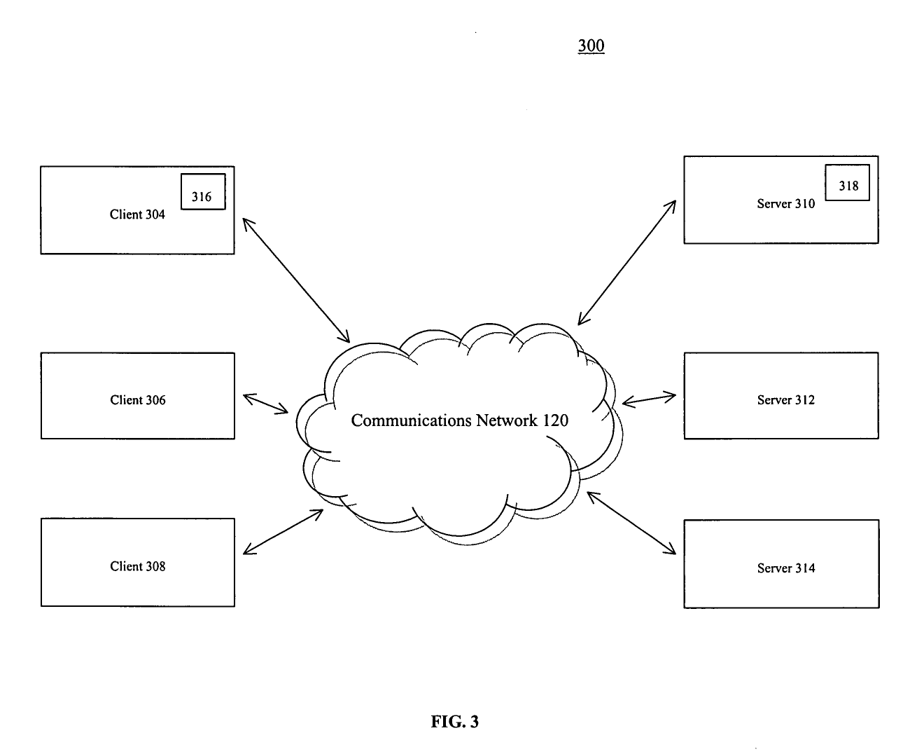

FIG. 3 illustrates an exemplary client-server environment 300. Client-server environment 300 includes the aforementioned communications network 120, which can be a national or an international network. It also includes a number of clients 304-308, and a number of servers 310-314. The clients 304-308 and the servers 310-314 are nodes connected to network 120, defined by their respective information retrieval functions.

Client 304 includes a client application 316, which is an information requesting or receiving application associated with client 304. Client application 316 either runs on client 304 or runs on another node and is passed to client 304.

Server 310 includes a server application 318, which is an information retrieval application associated with server 310. Server application 318 either runs on server 310 or runs on another node and is passed to server 310.

In operation, client application 316 is executed on client 304. In response, client 304 issues a request for information transmitted over network 120. The request is received by server 310, which executes server application 318. The requested information and/or services are then transmitted back to client 304 over network 120.

VI. Internet and World Wide Web Environment

A. Introduction

In these embodiments, an introduction of the Internet and how it is used in the context of the present invention is provided. As noted, network 120 can be any type of network, either private or public. In one or more embodiments, environment 300 (including network 120) refers to the Internet and World Wide Web (Web). In these embodiments, clients and servers transmit information in formats and media acceptable to the Internet and Web.

Internet refers to a worldwide system of interconnected computer networks that use the Transmission Control Protocol/Internet Protocol (TCP/IP) set of protocols. TCP/IP, in turn, typically refers to a bundle of network protocols, including: (i) the IP, a network layer protocol where unique IP addresses identify each network and each of its hosts, (ii) TCP, a connection-oriented protocol, where a connection is established via handshakes before any data is transmitted and (iii) certain application layer protocols, including telnet and file transfer protocol (FTP).

The parts of the Internet that are most widely used are electronic mail (e-mail) and the aforementioned Web. The Web is a network of computers located all over the world. These international computer networks can be comprised of clients and servers that users access to locate resources.

All the clients 304-308 and servers 310-314 in the Web can communicate with each other, and normally use a communication standard called Hypertext Transfer Protocol (HTTP). HTTP is an application protocol, i.e. a set of rules, for exchanging files on the Web that runs on top of TCP/IP.

The information on the Web is stored in documents called Web pages, which are files stored on the servers 310-314 comprising the Web. The clients 304-308 request the Web pages from the servers 310-314 (specifically server applications 318 running on the servers 310-314). More specifically, client applications 316 running on the clients 304-308 request the Web pages from server applications 318 running on the servers 310-314.

B. Displaying Information and Navigating on the Web

In these embodiments, the displaying of information and navigating on the Web in the context of the present invention is provided.

The client applications 316 are typically called Web browsers. Examples of well known browsers 316 that can be used with the present invention include Spry's Mosaic, Microsoft's Internet Explorer, and Netscape's Navigator. Browsers 316 are capable of understanding a variety of program languages used to design the Web pages, as well as protocols used to transmit the Web pages.

Web browsers 316 have varying levels of sophistication and functionality. Each screenful of information includes such items as highlighted words, graphics, menu choices, through which users can hyperlink (or “link”) to retrieve further information, either from the client 304-308 itself (for local files) or from servers 310-314 located on the Web. Table 2 contains common Internet terms known to skilled persons.

The manner of displaying the retrieved informational content in a web browser 316 is primarily according to formatting and display languages. Examples of formatting and display languages that can be used with the present invention include Hyper Text Markup Language (HTML), eXtensible Markup Language (XML), extensible HyperText Markup Language (XHTML), and Cascading Style Sheets (CSS).

HTML is used to create text files that contain markup tags, which inform the browser how to display the page. HTML files must have an “htm” or “html” file extension, and can be created using a simple text editor. XML is a markup language, permitting users to define their own markup tags. The markup tags in XML are not predefined as with HTML. XML uses a Document Type Definition (DTD) or an XML Schema to describe the data. While HTML was designed to display data, focusing on how the data appears, looks, XML was designed to describe data, focusing on the data itself, providing the ability to structure, store, and to send information. XML is pared-down version of Standard Generalized Markup Language (SGML), specifically designed for Web documents. SGML is a comprehensive system for the organization and tagging of document elements. Rather than specifying particular formatting, SGML specifies the rules for tagging elements. XHTML is the same as a version of HTML referenced as HTML 4.01. It is HTML defined as an XML application and applies a strictly defined version of HTML. CSS is used to design stylesheet pages, which define how the document is displayed or printed to the browser. CSS sheets can be attached to the HTML document itself. The cascading feature supported by CSS permits a single document to use two or more stylesheets, which are applied according to specified priorities.

The manner of formatting the information for retrieval from servers 310-314 and transmitting the retrieved information over network 120 are determined by protocols. A variety of protocols can be used to implement the present invention over the Internet, including the aforementioned HTTP, FTP, telnet, as well as, for example, Internet Relay Chat (IRC).

The main protocol (or set of rules for navigation and exchanging of files between clients and servers) used on the Web is HTTP, designed for exchanging files running on top of TCP/IP. HTTP not only defines how messages are formatted and transmitted, but also what actions Web server applications 318 and browsers 316 should take in response to various commands.

The act of using a client browser 316 to download a Web page located at a server application 318 can also be called navigating the Web, or browsing the Web, or linking to Web sites on the Web. Each Web page has a Web address called a Uniform Resource Locators (URLs). Consequently, Web pages are located by linking to the URL of a Web page and displaying it in the browser 316. Users can link to Web pages by selecting or clicking on menu choices, highlighted words, or graphics associated with URLs. When a user enters a URL in his/her browser, or otherwise attempts to link to a website, it causes an HTTP command to be sent to the appropriate Web server, directing it to fetch and transmit the requested Web page.

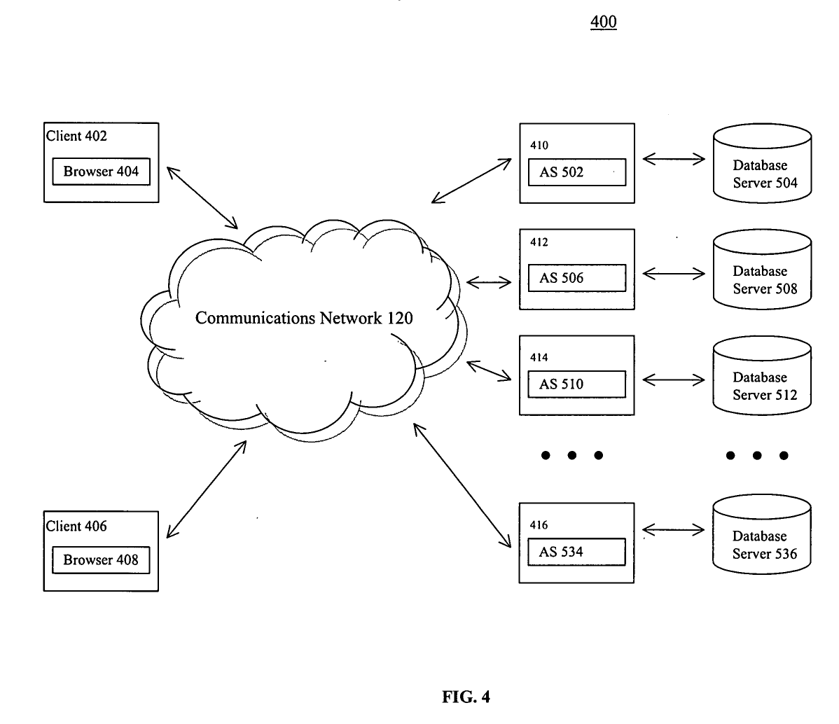

FIG. 4 illustrates a detailed exemplary client-server environment 400. Environment 400 of FIG. 4 includes the aforementioned communications network 120, a plurality of clients 402, 406 and a plurality of servers 410, 412, 414, 416, connected to network 120. The servers are shown connected to a plurality of database servers (DSs). Specifically, server 410 is connected to DS 504, server 412 is connected to DS 508, server 414 is connected to DS 512, and server 416 is connected to DS 536.

The clients 402, 406 and the servers 410-416 are nodes connected to network 120, defined by their respective information retrieval functions. Client 402 includes a client application 404, which is an information requesting or receiving application associated with client 402, and client 406 includes a client application 408, which is an information requesting or receiving application associated with client 406. Client applications 404, 408 can run either on clients 402, 406, respectively, or can run on another node and are then passed to the clients 402, 406. In one or more embodiments, the client applications 404, 408 are web browsers.

Servers 410-416 include a variety of processes, including operating systems, web server applications and application servers. The operating systems, which can also be called platforms, are the software programs that applications use to communicate with the physical parts of the servers 410-416. Examples of operating systems that can be used with the present invention include: Linux,™ Sun Solaris,™ Windows NT/2000,™ Cobalt RaQ™ and Free BSD,™ although any operating systems known or anticipated can be used.

The web server applications are software running on servers 410-416 that make it possible for the client browsers 404, 408 to download stored web pages. These applications also coordinate streaming audio, video, and secure e-commerce, and can be integrated with databases (as described below) for information retrieval. Examples of web server applications that can be used with the present invention include: Apache,™ Microsoft's Internet Information Server (IIS),™ O'Reilly & Associates WebSite Pro,™ Netscape's FastTrack Server,™ and StarNine's WebSTAR™ (for Macintosh), although any operating systems known or anticipated can be used.

The application servers sit on top of the formatting and display languages (for example, HTML) that a request from clients 402, 406 generate and translated the request for databases. Upon receiving information from databases, the application servers will translate this information back to the formatting and display languages and sent a response back to the browser. In one or more embodiments, the application server software resides at the servers 410-416, although with cross-platform programming technology, software performing the same functions can reside at clients 402, 406 as well. In one or more embodiments, the application servers will insert strings of programming code into the formatting and display language, with client browsers 404, 408 employing interpreters (or a plug-ins) to translate back into the formatting and display language (for example, HTML) to display a page. Examples of application servers that can be used with the present invention include: Cactus™, Cold Fusion™, Cyberprise Server™, Ejipt™, Enterprise Application Server™, Netscape Application Server™, Oracle Application Server™, PowerTier for C++™, PowerTier for Enterprise Java Beans™, Secant Extreme™, Enterprise Server™, SilverStream™, WebEnterprise™, WebSpeed™, and WebSphere,™ although any application servers known or anticipated can be used.

Taken together, the web servers and applications servers perform at least these functions: (i) providing an environment upon which server components can run; (ii) functioning as is a main program under which other components run as subroutines; (iii) providing services (for example, security related services, transaction related services), state management, and resources (for example, database connections); (iv) enabling communication with clients 402, 406.

The variety of processes running on servers 410-416 can be written using any program languages and types. Some or all of the programs can be cross-platform applications that additionally to running on the servers (or instead of running thereon) run on the clients 402, 404. Examples of cross-platform programs are Java applets, which run on clients, and servlets, which run on servers. Examples of programming languages that can be used with the present invention include: CGI™, Perl™, Java™, VBScript™, Python™, Microsoft ASP™, Java™, C++, Visual Basic, Enterprise JavaBean (EJB), although any languages known or anticipated can be used.

For the convenience of condensing terminology, the aforementioned applications working, which work together on the servers 410-416 (or instead are processed at other nodes and passed to servers 410-416) are referred to as “application servers.” FIG. 4 illustrates applications servers (ASs) 502, 506, 510, 534 respectively running on clients 410, 412, 414, 416. In operation, client browsers 404, 408 are used to issue requests for information, or queued to transmit information, over network 120. Requests and responses are handled by servers 410-416 via running of ASs 502, 506, 510, 534, which in turn transmit information over network 120 for display by browsers 404, 408.

In one or more embodiments, additional functions required of ASs 502, 506, 510, 534 will be to connect the web servers 410-416 to, for example, back-end data resources such as relational tables, flat files, e-mail messages, and directory servers. In exemplary embodiments, additional programs incorporated in ASs 502, 506, 510, 534 typically called “middleware,” database utilities, or database management systems (DMBS) can be used, among other known or anticipated database methods.

For example, the ASs 502, 506, 510, 534 can include their own internal DBMSs, or DBMSs of other nodes, or the DBMSs labeled database servers (DSs) 504, 508, 512, 536. The DBMS refers to computer software for storing, maintaining, and searching for data in a database. In the present invention, the DBMS can also utilize facilities for increasing reliability and performance, and integrity, such as indexes, logging, and record locking.

In one or more embodiments, the DBMS includes interfaces for searching for and locating particular data items from the database and for presenting the result of these queries to a search engine. A search engine as used herein searches the database in response to a user request, which can be initiated at client browser 402, 406, for example, or at server 502-504, for example, and returns a result to the user, for example in the form of a relational table viewable in browsers 404, 408. The DBMS can refer to any type of database, including a relational DBMS (RDBMS), LDAP,™ VSAM™, IMS™, Active Directory Services,™ message stores, to name a few.

In one or more embodiments, the DBMS is an RDBMS that uses relational database to retrieve information from the database. In one or more embodiments, the relational database uses structured query language (SQL™), including SQL defined according to International Standards Organization (ISO) and American National Standards Institute (ANSI) standards, or follow these standards with additional language constructs. In one or more exemplary embodiments, ASs 502-504 are respectively connected to DSs 504-536 via an application programming interface (API), including for example the open database connectivity (ODBC™), Java database connectivity (JDBC™), APIs.

In one or more embodiments, additional interfaces are used that can be employed for multiple types of databases, not just relational databases. One example is Microsoft's OLE-DB™ that provides access to all types of information, whether stored in RDBMS™, VSAM™, IMS™, Active Directory Services,™ message stores, among others.

Any types of DBMS platforms can be used in the present invention. Exemplary platforms employed include Sun Microsystems' Java™ 2 Platform, Enterprise Edition (J2EE),™ which contains an Enterprise JavaBeans™ (EJB) server-side component architecture, and Microsoft's Windows™ Distributed interNet Applications Architecture (Windows DNA™), which contains the COM+™ server-side component architecture.

TABLE 2

| INTERNET | |
|---|---|
| TERM | DEFINITION |
| ActiveXControl | A COM object that can be loaded from a server via inter- or intranet and |
| | run on any NT-client. |
| Browser | A Browser (or Web Browser) is a computer application that fetches Web |
| | pages from servers on the Internet and displays them on the user's local |
| | machine. |
| CML | Chemical Markup Language is an XML schema designed for handling |
| | information concerning chemical substances. |
| COM | Component Object Model is an MS-paradigm for connecting |
| | components, which has implemented the base technology for COM on |
| | the NT platform. |
| CSS | Cascading Style Sheets refers to a W3C Recommendation for files that |
| | when attached to a document will describe how the document is to be |
| | displayed or printed. |
| DHTML | Dynamic HTML is a standard for extending HTML that consists of |
| | HTML 4.0, DOM, CSS, and certain scripting languages. |
| DocBook | DocBook refers to XML and SGML DTDs and DSSSL/XSL stylesheets |
| | owned by OASIS for use in modeling manuals and converting them. |
| DocZilla | DocZilla is the Web browser offered by CITEC that can render XML, |
| | SGML, and HTML documents. |
| DTD | Document Type Definition refers to a specification for schema |
| | specification for SGML and XML documents. The DTDs can be |
| | contained within a document or belong to an external subset that is |
| | referenced. Examples of DTDs include HTML, DocBook, CML, and |
| | IBTWSH. |
| ebXML | electronic business XML, A project jointly initiated by UN/CEFACT (=The |
| | United Nations body for Trade Facilitation and Electronic Business) |
| | and OASIS to standardize XML business specifications. ebXML intends |
| | to develop a technical framework that will enable XML to be utilized in a |
| | consistent manner for the exchange of all electronic business data. |
| FTP | File Transmission Protocol refers to an application protocol for |
| | exchanging files over top of TCP/IP. FTP can be used to upload a |
| | webpage to a server. |
| HTML | Hypertext Markup Language is a DTD that consists of both text and tags |
| | widely used for performing document layout and performing |
| | hyperlinking. Java applets can be included using an <APPLET> tag. |
| | The current W3C version of HTML is HTML 4.0, which is also known |
| | as XML-compatible HTML (XHTML). |
| HTTP | Hypertext Transfer Protocol is the application protocol that controls the |
| | exchanging of files on the Web, and is within the architectural domain of |
| | W3C. |
| IE | Internet Explorer, the leading web-browser offered by Microsoft and |
| | provided free-of-charge with Microsoft operating systems. |
| Internet | A worldwide system of computer networks based on the TCP/IP set of |
| | protocols. Its most widely used parts are electronic mail (e-mail) and the |
| | World Wide Web (WWW). |
| Intranet | A private network that is contained within an enterprise using TCP/IP, |
| | HTTP, and other Internet protocols. Intranets may include connections |
| | through gateway computers to the Internet using firewall servers for |
| | security. |
| IP | Internet Protocol, protocol in the TCP/IP internet layer for |
| | communication between nets and their hosts. An IP-address uniquely |
| | identifies each network and each of its hosts on the internet. Addresses |
| | consist of four bytes that can be represented by four integers (0 to 255) |
| | separated by dots, e.g. “157.189.162.75”. Dependent on the address' class |
| | and a subnet mask, a specific number of bits identify the net or subnet |
| | and the rest a PC's address within this net/subnet. |
| ISO | ISO is the acronym for the International Organization for |
| | Standardization, which is an influential international federation of |
| | national standards organizations from over 100 countries. |
| Java | Java is an object oriented programming language that is cross-platform |
| | compatible and supports multithreading. Java is executed on any |
| | platform using the Java Virtual Machine (JVM). |
| Java Applet | A component written in Java, that can be downloaded from a server via. |
| | an intra- or internet and executed on a client. The applet runs in a |
| | sandbox, e.g. the security settings only allow the applet to access data |
| | located on the server the applet is downloaded from. Most browsers |
| | contain a Java Virtual Machine (JVM) and are thus capable of running |
| | applets. |
| JavaBeans | JavaBeans refers to a Java component model where reusable “beans” are |
| | created using a Bean Development Kit (BDK). |
| Netscape | Netscape Navigator refers to Netscape's web-browser, which is currently |
| Navigator | part of Netscape Communicator. |
| SGML | Standard Generalized Markup Language is the standard for documents |
| | adopted in 1986 by the ISO for defining documents using DTDs. |
| | Document contents are identified by using semantic tags. |
| Tag | A tag is a vanilla term for a language element descriptor. Markup usually |
| | refers to the set tags for a document. |
| TCP | Transmission Control Protocol is a transport layer protocol, which is |
| | used to establish a proper connection (hand shaking) before any data is |
| | transmitted. |
| TCP/IP | Transmission Control Protocol/Internet Protocol refers to the two |
| | primary Internet protocols, namely the Internet Protocol IP (from which |
| | colloquial usage of the term “Internet” comes) and Transport Protocol |
| | TCP. It can also refer to certain application protocols, including FTP and |
| | telnet. |
| URL | Universal Resource Locator refers to the unique address of a document or |
| | a resource on the Internet. |
| W3C | The World Wide Web Consortium is an influential industry consortium |
| | promoting and maintaining the standards for the Web. The consortium |
| | also handles interoperability issues between Web products through its |
| | production of specifications and reference software. |
| WAP | Wireless Application Protocol refers to the primary standard for |
| | accessing the Internet using wireless devices. |
| WML | Wireless Markup Language refers to the DTD used in WAP. (see above) |
| WWW | World Wide Web, or simply Web, refers to the resources and users on |
| | the “Internet” using the Hypertext Transfer Protocol (HTTP). |
| XHTML | Extensible HyperText Markup Language refers to a reformulation of |
| | HTML 4.0 in XML 1.0. |
| XMLHTTP | This term refers to “Microsoft.XMLHTTP” or an “XMLHttpRequest |
| | Object”, which refer to the ActiveXControl enabling access to instances |
| | of HTTP request. |

VII. Online Sports Auction

A. Overview

In the remainder of the description portion of the specification, the technology discussed in the foregoing sections is applied to a specific type of environment.

In one or more embodiments, the present invention is described with respect to an online person-to-person environment between individuals who purchase sponsorship (“sponsorship purchaser user entities”) and individuals who sell sponsorship (“sponsorship seller user entities”). In other words, the real-life “entities” or “user entities” that can be used with the present invention include purchasers, who desire to obtain sponsorship, for example at a sports event, and sellers, who desire to sell sponsorship, for example at a sports event.

For example, the sponsorship to be sold can comprise on-the-vehicle sponsorship in a motorsports event. Examples of motorsports racing events include National Association for Stock Car Auto Racing (NASCAR) racing events, for example (i) NASCAR Craftsman™ Truck Series racing events, (ii) NASCAR Busch™ Series racing events, or (iii) the NASCAR Nextel™ Cup Series racing events.

However, it is important to note that the present invention is not limited to motorsports, or for that matter, NASCAR racing events. For that matter, the present invention can be used with respect any type of sports events where sponsorship is used or displayed. In addition, sponsorship, as used in the present invention, also need not be limited to sponsorship at the sports event itself, but can pertain to any sponsorship, advertisement, or endorsement associated with a sporting or other entertainment services related event.

Examples of types of advertising and sponsorship opportunities include traditional means (print forms like newspapers, magazines, brochures, newsletters, press releases and billboards, to event-related activities, like sponsorships, seminars, point-of-sale and promotional programs, broadcast media, like radio, television, cable and recently satellite cable), more targeted advertising and sponsorship tailored to individual consumers (direct advertising new endeavors designed to interact directly with consumers through pull campaigns and push campaigns, measurable advertisers campaigns using specific consumer data mining bearing on consumer buying habits, trending and predicting future habits), advances in technology outlets combined with marketing ingenuity that have expanded old direct mail marketing campaigns into new branches (telemarketing, point-of-sale campaigns, computer platforms, and most recently distribution and measurement through telecommunications networks), and Internet advertising (branded websites, banner ads, pop-up ads, targeted e-mails, portal sponsorships).

In addition, in one or more embodiments, the Integrated Marketing Vehicle Platform (IMVP), described in a parent hereof, incorporated herein by reference in its entirety, can be used in combination with the present invention. IMVP permits skilled persons the opportunity for integration and cross-platform branding, advertising, sponsorship, and promotion. By way of example, and not by way of limitation, traditional sponsorships (such as traditional racing vehicle sponsorships) can be integrated with real-time wireless and online promotions, as well as demographics, psychographics, previous consumer responses, and brand entity specific metrics.

In particular, IMVP permits advertisers, ad agencies, broadcasters, sponsors, and any other entities desiring to manage and modify consumer behavior, called “brand entities,” to (i) properly gather and use consumer information, from demographics, to psychographics, to previous purchasing habits, and based on the desires of brand entities, gage consumer demands, on everything from current buying habits to affiliations with hobbies and athletic activities; (ii) to cross promote their products and trademarks across various types of platforms, including technologies, networks, protocols, interest groups, to name a few; (iii) to elicit real-time consumer responses and interest in a way that is measurable, dynamic, and interactive; and (iv) to enhance consumer participation and experience, and effect long term product sales, through loyalty, redemption and incentive programs.

IMVP also provides a dynamically accessible and programmable marketing tool, capable of collecting and assessing user data from existing and potential consumers in real-time, across multiple platforms. Brand entities can use the tool to promote short term sales, promote long term behavior, establish rapport and brand recognition with their consumer base and promote consumer branding affiliations.

It is also important to note that method and apparatus described herein are equally relevant to other types of “entities,” including sponsorship providers and recipients, various legal entities, technical entities, and environments, for example, e-commerce or otherwise, wherever there is an interaction between two parties. As the present invention is not limited to use by sponsorship purchasers and sponsorship sellers, it can be used or incorporated by any individuals who wish to pay for or barter for goods or services, and other individuals who provide such goods or services.

Specifically, in one or more embodiments, the present invention is described with respect to an online person-to-person environment between individuals who purchase automotive goods (“goods purchaser user entities”) and individuals who sell automotive goods (“goods seller user entities”). For example, the real-life “entities” or “user entities” that can be used with the present invention include purchasers, who desire to obtain automotive goods after such goods have been used in motorsports racing events, from sellers, who desire to sell such goods.

The sellers and purchasers are also not limited to persons, and can include businesses (such as partnerships, limited liability partnerships (LLPs), corporations, limited liability companies (LLCs), trusts), teaching institutions (such as universities, research facilities), governments (local, state, country), or any other entities legally entitled to use the present invention.

Furthermore, the entities can also include machines (hardware and/or software) or other automated facilities affiliated with the aforementioned categories. For example, in the present invention, a “sponsorship purchaser user entity” can be a corporation, a business unit of the corporation, or one or more processes representing the corporation or business unit. Therefore, although such terms as “sponsorship purchaser user entity,” “sponsorship seller user entity,” “sponsorship purchaser,” and “sponsorship seller” are used throughout, there are many other “entities” or “user entities” that can use and inter-connect with the features and functions of the present invention.

In one or more embodiments, the online marketplace community known as eBay™ is the online sports system described with respect to the present invention, which is the Internet marketplace for sponsorship. Here, the buyers (for example, sponsorship purchaser user entity or goods purchaser user entity) and sellers (for example, sponsorship seller user entity or goods seller user entity) described herein are eBay™ users. In one or more of these embodiments, the sponsorship is sold from willing buyers to willing sellers through one or more auctions provided on eBay.™ However, the present invention is not limited to eBay™ auctions and can be used with respect to any online system or auction. In fact, the present invention can be used for non-auction based websites, and through the technologies described herein, including through any of the aforementioned types of devices, for example wireline or wireless devices.

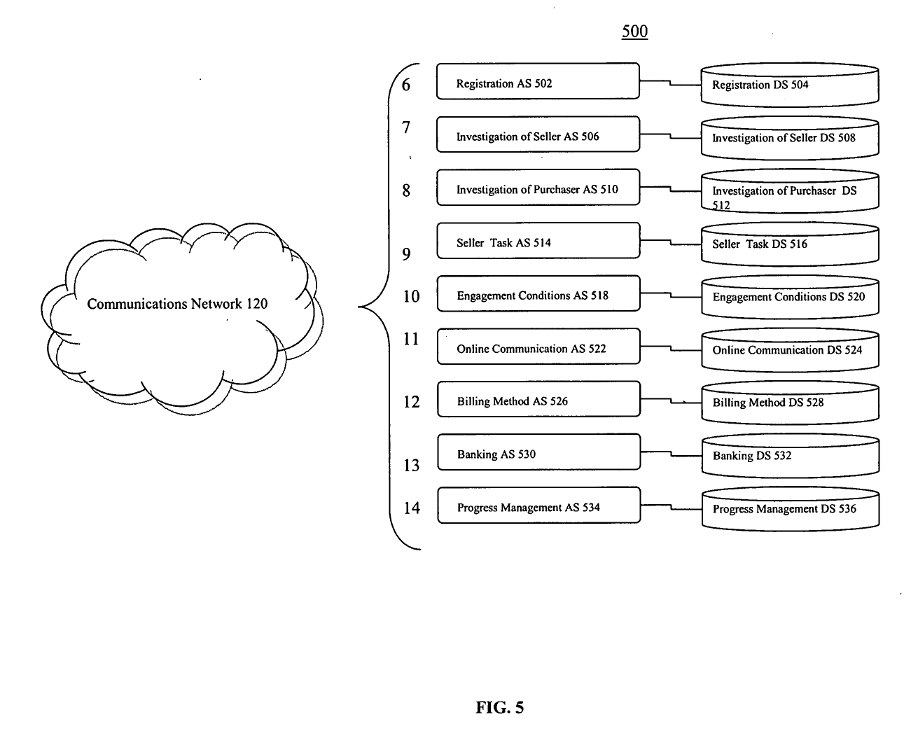

Referring to FIG. 5, the structure and functions of the present invention are described with respect to a modular structure, specifically through the application servers and database servers described with respect to FIG. 4. The application servers perform the described functions and database servers store one or more portions or subportions of the data accessed and otherwise used by the applications servers.

Each application server and/or database server shown is representative only, and can refer to a plurality of application servers and/or database servers working together. More importantly, as will be recognized by skilled persons, the features and functions described below are not limited to the example environment of FIG. 5, and can be performed by any of the technologies described above in sections I-VI.

Referring back to FIG. 5, illustrated are application server-database server pairs, specifically registration application server (AS) 502, registration database servers (DS) 504, investigation of seller AS 506, investigation of seller DS 508, investigation of purchaser AS 510, investigation of purchaser DS 512, seller task AS 514, seller task DS 516, engagement conditions AS 518, engagement conditions DS 520, online communication AS 522, online communication DS 524, billing method AS 526, billing method DS 528, banking AS 530, banking DS 532, and progress management AS 534, progress management DS 536.

The following embodiments describe the features and functions associated with the above-noted application servers, and exemplary types of data stored by the database servers. The embodiments also illustrate exemplary GUIs, for examples web pages, having one or more fields for informational content. The informational content can be (i) shown to individuals or entities, (ii) or stored, or maintained in the aforementioned database servers, or (iii) processed, downloaded, or uploaded by and from the aforementioned application servers, or (iv) processed, downloaded, or uploaded by and from client servers of user entities (for example, seller user entities, purchaser user entities) who use the present invention. For example, a GUI can be displayed to a sponsorship seller user entity using browser 404 of client 402, or a sponsorship purchaser user entity using browser 404, 408 of client 406.

The name used for the user community service system of the present invention, including the associated features and functions, is termed “Online Sports system,” or sometimes simply “Community Service,” though skilled persons will recognize that any name or nickname can be used.

B. Registration

Registration AS 502 and DS 504 maintains and updates the contents for a Homepage for the Online Sports system users. Initially, the user (for example, seller or buyer) enters an online Sports system Homepage. The Homepage includes a variety of informational content for the user, differing varieties of which will be recognized by skilled persons. The standard Homepage features provide users the ability to: (i) initially register online, (ii) locate and track registered users who are currently online and who are not currently online, (iii) find personal and professional information on Online Sports system users, (iv) receive access to a site map, (v) create personalized web pages (or series of web pages) providing a user access to the Online Sports system features considered most important, and the ability to store personalized information (in one example embodiment, called myOnlineSports), (vi) sign in, if already registered as a user, or update personal features, if already registered, (vii) receive help information, if the user is new, or has not previously learned all the features and functions of the Online Sports system. There are also many other varied and unique features and functions provided to an online Sports system user, as described in detail below.

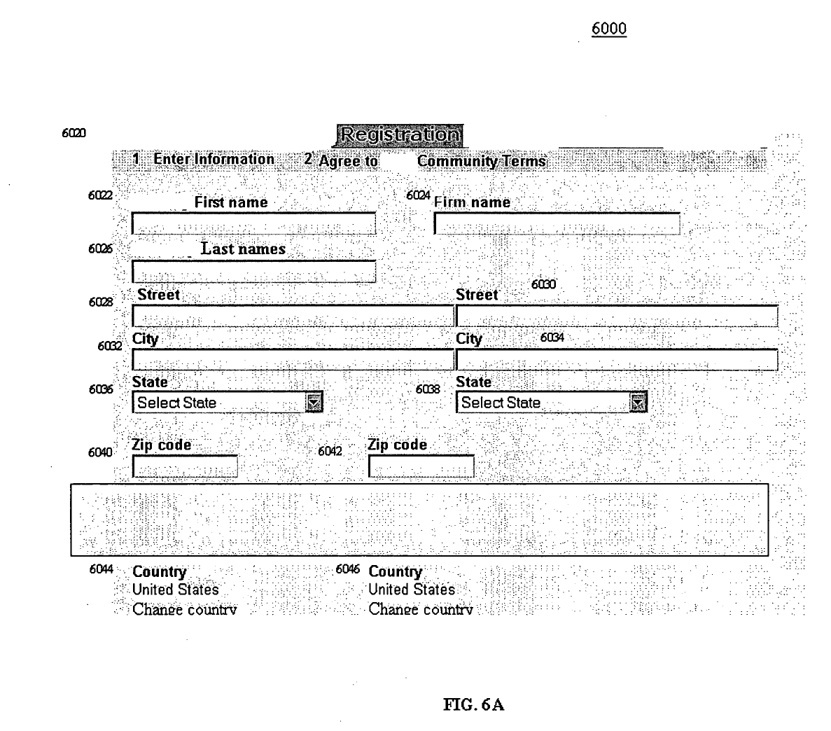

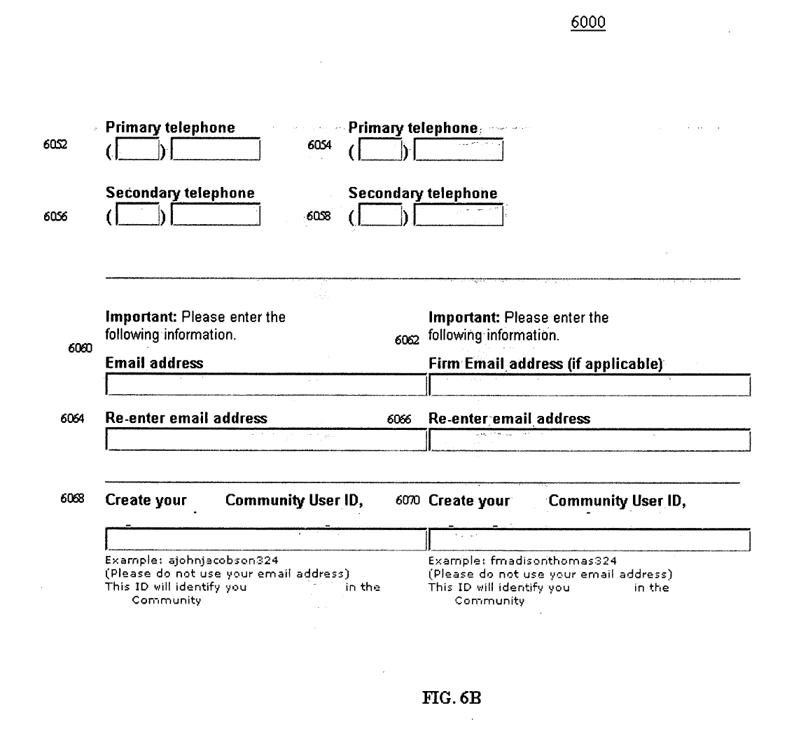

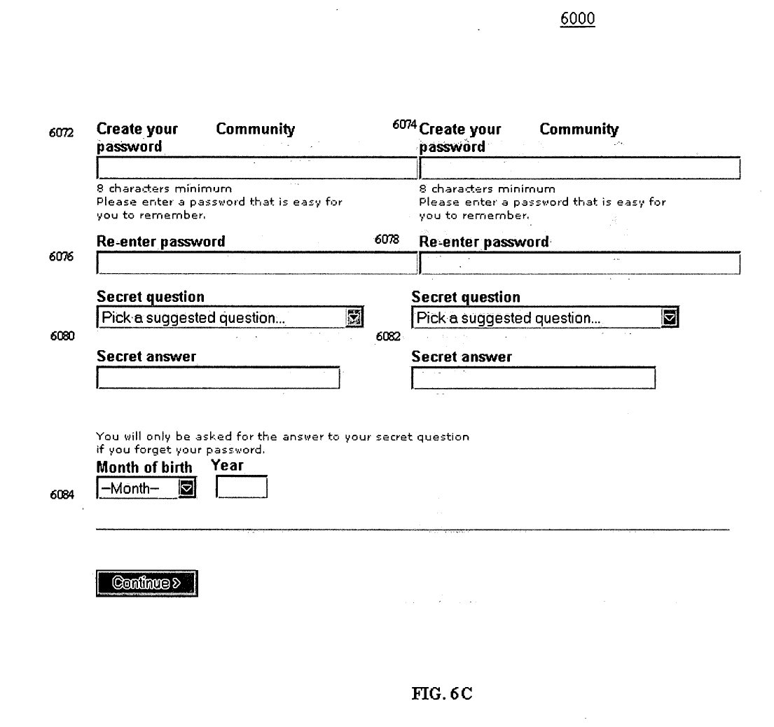

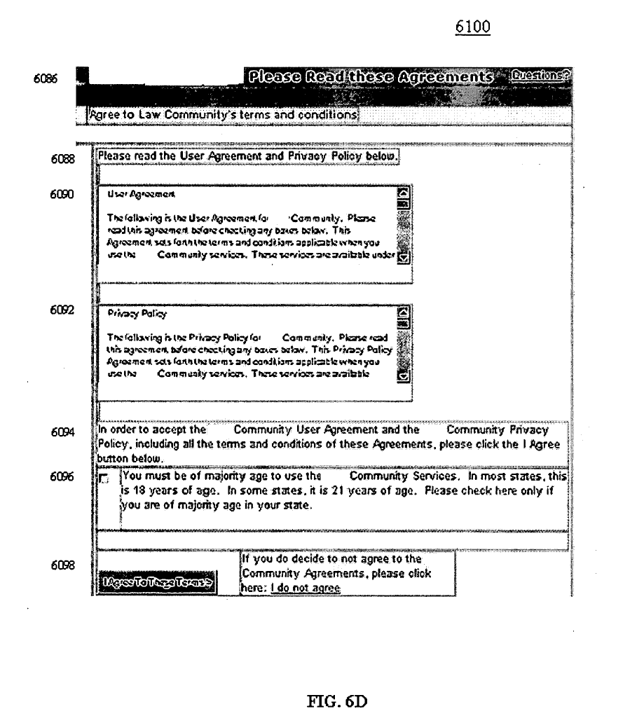

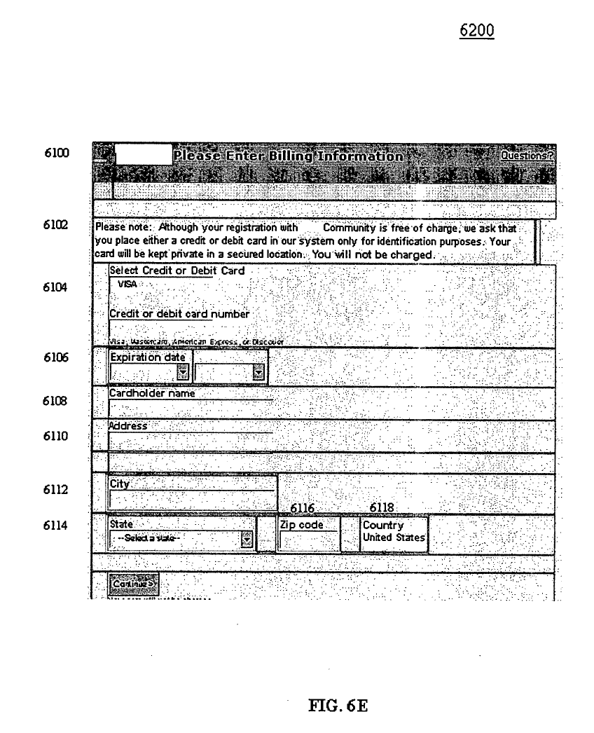

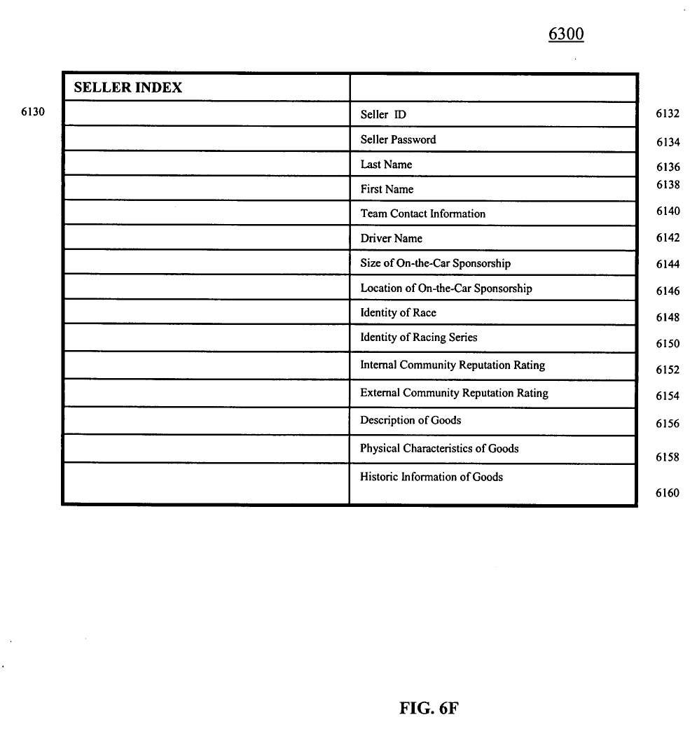

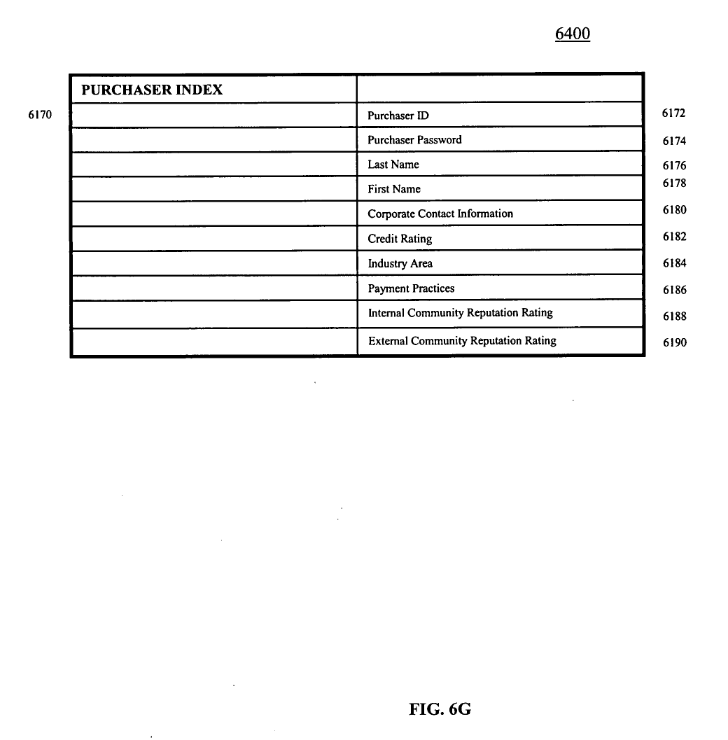

Registration AS 502 and DS 504 stores a variety of information for each user entity (including, for example, a purchaser user entity, a seller user entity) that uses the system. FIGS. 6A, 6B and 6C respectively illustrate the exemplary first, second and third portions of a web page for registration of sellers, which are stored, maintained, uploaded/downloaded, and processed on the Online Sports system. Table 3 includes a list of the fields that are displayed to sellers (and/or their companies or firm entities), and solicit information from these users, for registration.

TABLE 3

| USER REGISTRATION | |
|---|---|
| FIELD | DESCRIPTION |
| 6020 | Identifies that the registration is for sellers and firms. |
| 6022 | Seller first name |
| 6024 | Firm name |
| 6026 | Seller last name |
| 6028 | Seller street address |
| 6030 | Firm street address |
| 6032 | Seller city |
| 6034 | Firm city |
| 6036 | Seller state |
| 6038 | Firm state |
| 6040 | Seller zipcode |
| 6042 | Firm zipcode |
| 6044 | Seller country |
| 6046 | Firm country |
| 6052 | Seller primary telephone number |
| 6054 | Firm primary telephone number |
| 6056 | Seller secondary telephone number |
| 6058 | Firm secondary telephone number |
| 6060 | Seller e-mail address |
| 6062 | Firm e-mail address |
| 6064 | Re-entry of seller e-mail address |
| 6066 | Re-entry of firm e-mail address |
| 6068 | A user-defined identification (userid or ID) for the seller on the |
| | Online Sports system. In one embodiment, an seller is required to |
| | make the first character of his/her userid begin with an “a” for |
| | seller. |
| 6070 | A user-defined identification (userid or ID) for the firm on the |
| | Online Sports system. In one embodiment, a firm is required to |
| | make the first character of his/her userid (or ID) begin with an “a” |
| | for seller. |
| 6072 | A password for the seller on the Online Sports system. In one |
| | embodiment, the password is required to be at least 8 characters |
| | long, and can be defined by the seller user. |
| 6074 | A password for the firm on the Online Sports system. In one |
| | embodiment, the password is required to be at least 8 characters |
| | long, and can be defined by the firm user. |
| 6076 | Re-entry of the seller password, required for verification that the |
| | seller user has correctly entered his/her password as he/she. |
| 6078 | Re-entry of the firm password, required for verification that the |
| | firm user has correctly entered his/her password as he/she. |
| 6080 | A secret question to be predefined by the seller user, so that he/she |
| | can long into the system even if he/she forgets his/her password. In |
| | the illustrated embodiment, the seller user selects the secret |
| | question from a predefined list. |
| 6082 | A secret question to be predefined by the firm user, so that he/she |
| | can log into the system even if he/she forgets his/her password. In |
| | the illustrated embodiment, the firm user selects the secret question |
| | from a predefined list. |
| 6084 | The user seller inputs his/her month and date of birth. |
| 6086 | Identifies that the terms and conditions are for sellers and firms. |
| 6088 | Advises sellers and firms to please read the terms and conditions. |
| 6090 | The full user agreement for sellers and firms. |
| 6092 | The full privacy agreement for sellers and firms. |
| 6094 | Advises sellers and firms to click a button to agree to the terms and |
| | conditions for using the Online Sports system. |
| 6096 | Advises the seller or person signing in as a firm that they must be |
| | of age of majority. |
| 6098 | Permits the user to agree or not agree to the terms and conditions. |
| 6100 | Identifies for purchasers that the web page is for the entry of billing |
| | information. |
| 6102 | Purchaser is advised that he/she will not be billed and that billing |
| | information is solicited only for signing up with the Online Sports |
| | system, and will be kept confidential. |
| 6104 | Purchaser payment type (for example, VISA, AMEX) is solicited, |
| | as well as card number. |
| 6106 | Purchaser payment type expiration date is solicited. |
| 6108 | Purchaser name, as cardholder, is solicited. |
| 6110 | Purchaser address information is solicited. |
| 6112 | Purchaser city information is solicited. |
| 6114 | Purchaser state information is solicited. |
| 6116 | Purchaser zipcode information is solicited. |
| 6118 | Purchaser country information is solicited. |

Skilled persons will recognize there are many ways the Online Sports system can store, maintain, upload/download and process the information for an entity using a browser 404 at client 402. In fact, any of the foregoing technologies can be used for these operations. As one example, that will be recognized to skilled persons, (i) the GUI interface (for example, web page) will be downloaded to browser 404 from registration AS 502, and the information entered by an entity at browser 404 will be uploaded to registration AS 502, using HTTP GET/POST commands; (ii) registration AS 502 will save the information at registration DS 504, and retrieve the information from registration DS 504, for downloads of requested information to browser 404 or processing of the information for downloads. Because these features and functions are known to skilled persons, and furthermore because an extensive discussion of various technologies that are used (and can be used) in the present invention were described above (in sections I-VI), such discussions will be omitted for the following embodiments.

Registration information for purchasers can be the same as the illustrated in FIGS. 6A-6C, or can be varied based on the needs of the Online Sports system, seller user entities, or other user entities.

In one embodiment, users are requested to verify that they have read a user agreement and a privacy agreement. Again, this information is processed and maintained by the registration AS 502 and DS 504. FIG. 6D illustrates a web page GUI for this embodiment where the users are sellers or their respective firm (for example, corporation owner) entities. Table 3 also includes a list of the fields that are displayed to sellers and firm entities, and solicit information from these user entities, for this embodiment. Verification of a purchaser's review of a user agreement and a privacy agreement can be the same as illustrated in FIG. 6D, or can be varied based on the needs of the Online Sports system, individual sellers or other entities. For example, it may be advantageous to have differing terms and conditions for purchasers than for sellers.

In one embodiment, billing information is solicited upon registration with the Online Sports system. Again, this information is processed and maintained by the registration AS 502 and DS 504. FIG. 6E illustrates a web page GUI for this embodiment where the users are purchaser user entities. Table 3 also includes a list of the fields that are displayed to purchaser user entities, and solicit information from these user entities, for this embodiment. Providing of billing information by other user entities, such seller and firm user entities, can be the same as illustrated in FIG. 6E, or can be varied based on the needs of the Online Sports system and other entities. For example, it may be advantageous to have billing information provided only by purchasers upon registration, or to have the billing information provided by entities paying for goods/services (for example, purchaser user entities) processed differently than the billing information for entities providing such goods/services (for example, seller user entities).

The above-noted information is not the only information that can be stored, maintained, uploaded/downloaded, and processed on the Online Sports system. Any information that would be useful for user entities, for example purchaser user entities, seller user entities, firm entities, or other above-noted user entities, can be included and used in the present invention. Examples are illustrated and described below.

For example, registration AS 502 and DS 504 can store, maintain, upload/download and process any fields regarding sellers pertinent for purchasers. The aforementioned pertains to both services offered, such as sponsorship related services, or goods provided, such as auto parts.

FIG. 6F illustrates an exemplary seller index. To begin with, the index contains pertinent information that is general in nature. This includes seller userid (or ID) 6132, seller password 6134, seller last name 6136, seller first name 6138, and team contact information 6140.

For the service of on-the-vehicle sponsorship, the index includes the name of the racing driver 6142, the size of the on-the-vehicle sponsorship 6144, the location of the on-the-vehicle sponsorship 6146, the identity of the racing event for the sponsorship 6148, the identity of the racing series (for example, the NASCAR Nextel Cup Series) 6150, the reputation rating of the seller within the Online Sports System (for example, feedback from other Online Sports System users, to inform other users about the seller's reliability) 6152, and the reputation rating of the seller outside the Online Sports System (for example, feedback from individuals or entities who are not Online Sports System users, about the seller's reliability) 6154.

For goods that are offered through the Online Sports System, one exemplary embodiment is the selling of automotive parts that have been previously used in racing events to racing enthusiasts. The index includes exemplary information useful to purchasers about the seller, including the description of the goods 6156, the physical characteristics of the goods 6158, and historical information or data regarding the goods 6160. The aforementioned reputation ratings, both internal and external, are also useful to prospective purchasers.

Similarly, registration AS 502 and DS 504 can store, maintain, upload/download and process any fields regarding purchasers pertinent for sellers. The aforementioned pertains to both services offered, such as sponsorship related services, or goods provided, such as auto parts.

FIG. 6G illustrates an exemplary purchaser index. To begin with, the index contains pertinent information that is general in nature. This includes purchaser userid (or ID) 6172, purchaser password 6174, purchaser last name 6176, purchaser first name 6178, and corporate contact information 6180. The index also includes more specific information useful for the seller. This includes the seller credit rating (obtained either from other users internally, or externally, for example, via a Dunn & Bradstreet™ report) 6182, the industry area for the seller 6184, the previous payment practices for the seller (gathered either externally from information external to the Online Sports system, or internally, from information internal to the Online Sports system) 6186. Additional fields are the seller's internal community reputation rating 6188 and external community reputation rating 6190.

Any user entity can search, query, browse, any categories relating to registration method, whether using information resident in the Online Sports system, or using external information.

C. Investigations of Sellers

In these embodiments, a party receiving goods/services (for example, a purchaser user entity) can investigate and retrieve information regarding a party providing goods/services (for example, a seller user entity). The investigation can be based upon any criteria or features associated with sellers.

Investigation of seller information can be provided to and gathered from the seller user entity (or their firm user entities), for example at his/her browser 404, and stored, maintained, uploaded, downloaded, and processed on the Online Sports system, and processed and/or displayed for a purchaser user entity at his/her browser 408. In these embodiments, the investigation of seller information is processed and maintained by the investigation of sellers AS 506 and DS 508.

Any of the aforementioned fields provided to registration AS 502 and DS 504, during initial enrollment, or later, in addition to any other fields, can be stored, processed, queried, browsed, or otherwise manipulated and displayed.

For example, in one embodiment, the purchaser user entity desires to purchase a sponsorship in the NASCAR Nextel Cup series, for the Mansfield, Ohio race. The user can perform online searches or browse for the teams offering such sponsorship, and is availed to the information of FIG. 6F, and any other information such user can deem useful to making a purchasing decision. The purchaser can make the purchasing decision based on the perceived quality of the team, reputation of the driver, the relative size and location of the on-the-vehicle sponsorship, etc. The user can purchase through an online auction, or purchase directly.

As another example, in one embodiment, the purchaser user entity is a racing enthusiast who desires to purchase racing quality used auto parts from a racing team. The user can perform online searches or browse for the teams offering such automotive parts, and is availed to the information of FIG. 6F, and any other information such user can deem useful to making a purchasing decision. The purchaser can make the purchasing decision based on the perceived quality of the parts, the age of the items, the wear and tear on the item, or based on the historical information relating to the item. The purchasing decision can be based on any items deemed relevant to the purchaser, including for memorabilia, aficionado, or sports admirer based reasons. The user can purchase through an online auction, or purchase directly.

Any user entity can search, query, browse, any categories relating to the investigation of sellers (or other provider user entities), whether using information resident in the Online Sports system, or using external information.

D. Investigations of Clients

In these embodiments, a party providing goods/services (for example, a seller user entity) can investigate and retrieve information regarding a party receiving goods/services (for example, a purchaser user entity). The investigation can be based upon any criteria or features associated with sellers.

Investigation of purchaser information can be provided to and gathered from the purchaser user entities, for example at his/her browser 408, and stored, maintained, uploaded, downloaded, and processed on the Online Sports system, and processed and/or displayed for the seller user entity at his/her browser 404. In these embodiments, the investigation of purchaser information is processed and maintained by the investigation of purchasers AS 510 and DS 512.

In one embodiment, any of the aforementioned fields provided to registration AS 502 and DS 504, during registration (or later), can be stored, processed, queried, browsed, or otherwise manipulated and displayed.

The investigation of purchasers AS 510 and DS 512 can process and maintain pertinent information regarding purchasers in any particular manner desired by a provider, and download such information in their browser 404.

For example, a sponsorship seller user entity can select to browse only companies that are industry areas considered important or relevant to the purchaser user entity. In motorsports racing, for example, it is often the case that primary on-the-vehicle sponsors, which pay highest revenues for very large logos/decals have particular preferences regarding other companies that a racing team may advertise on the racing vehicle. Such smaller sponsors are often termed associate sponsors. Primary sponsors have various business reasons for their preferences regarding associate sponsors, including whether the associate sponsor is a competitor company, or in the alternative, desires to establish a co-branding association with the associate sponsorship due to complimentary goods/services it offers. Hence, it can be quite useful for a team desiring to sell on-the-vehicle sponsorship to choose such associate sponsors from industry areas, or products/service rendered, or other factors deemed relevant.

In response to an SQL query to DS 512, AS 510 receives and downloads to the sponsorship seller user entity's browser the exemplary list of the industry areas. The client user can then hyperlink from these industry areas to retrieve a list of purchaser user entities in the selected industry areas. The sponsorship purchaser user entity can also select to browse the purchasers within a particular industry sub-areas falling within an industry area. In response to an SQL query to DS 512, AS 510 receives and downloads to the sponsorship seller user entity's browser the requested list of industry areas and sub-areas.

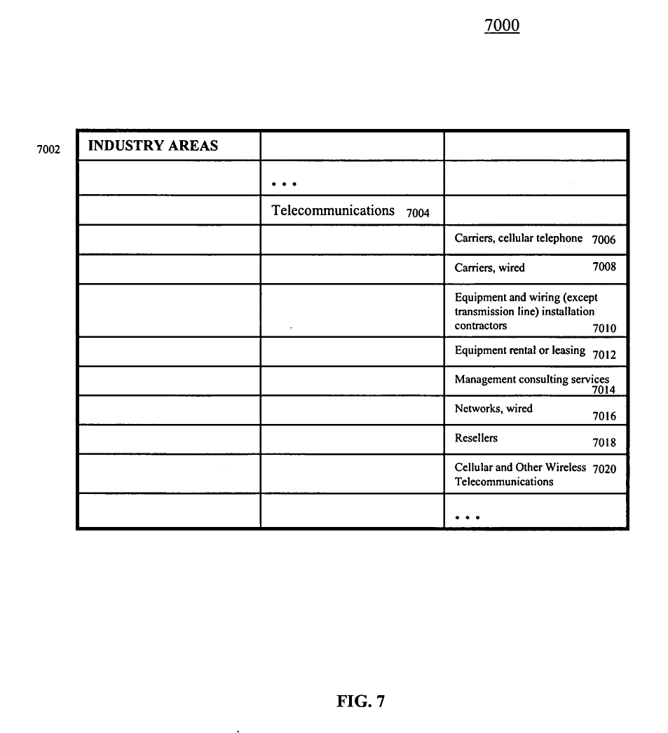

FIG. 7 illustrates such an exemplary industry area database that can be shown to a sponsorship seller user entity, in his or her browser 404, when investigating a sponsorship purchaser user entity. There are many industry areas 7002, of which only the telecommunications industry area 7004 is shown. The telecommunications industry area 7004 includes a number of sub-areas, including: carriers, cellular telephone 7006, carriers, wired 7008, equipment and wiring (except transmission line) installation contractors 7010, equipment rental or leasing 7012, management consulting services 7014, networks, wired 7016, resellers 7018, and cellular and other wireless telecommunications 7020. The sponsorship seller user entity can hyperlink from any of the sub-areas to retrieve a list of all purchaser user entities on the Online Sports system who fall within such a sub-area.

To continue with the example, in one embodiment, the seller user entity desires to sell a sponsorship in the NASCAR Nextel Cup series, for the Mansfield, Ohio race. The user can perform online searches or browse for the companies desiring to purchase such sponsorship, and is availed to the information of FIG. 6F, and any other information such user can deem useful to making a selling decision. The seller can make the decision regarding which parties to consider as prospective customers based on the aforementioned industry area of the purchaser user entity, as well as its credit ratings, payment practices, reputation within the Online Sports system, or any other parameters deemed relevant. The user can purchase through an online auction, or purchase directly.

As another example, in one embodiment, the seller is a racing team desiring to sell racing quality used auto parts to corporations. The user can perform online searches or browse for the companies desiring to purchase such automotive parts, and is availed to the information of FIG. 6F, and any other information such user can deem useful to making a purchasing decision. The purchaser can make the purchasing decision, for example, based on the reputation of the purchaser user entity outside the Online Sports system, the credit rating of the purchaser user entity, the industry area of the purchaser user entity, the payment practices of the purchaser user entity, or any other parameters deemed relevant. The user can purchase through an online auction, or purchase directly.

Any user entity can search, query, browse, any categories relating to the investigation of purchasers (or other recipient user entities), whether using information resident in the Online Sports system, or using external information.

E. Goods/Services Listings

In these embodiments, a party who desires to receive goods/services (for example, a purchaser user entity) can post a listing of the goods/services for viewing and establishing of an engagement relationship with a provider (for example, a seller user entity). The information provided by the party who desires to receive goods/services can be any information such party and/or a provider will deem important in establishing an engagement relationship, whether internal to the Online Sports system or external to it. In this manner, purchaser user entities can receive work, services, performances, goods or products from seller user entities.

The aforementioned information can be extracted from, for example, a purchaser user entity, using his or her browser 408, with the information being stored, maintained, uploaded, downloaded, and processed on the Online Sports system, and processed and/or displayed for the seller user entity at his/her browser 404. In these embodiments, the processing and maintaining of information is performed by the client task AS 514 and DS 516.

In one embodiment, any of the aforementioned fields and information provided to registration AS 502 and DS 504, during initial enrollment, or later, can be stored, processed, queried, browsed, or otherwise manipulated and displayed. In another embodiment, any of the fields and information provided to progress management AS 534 and DS 536, which are described below in detail, can be stored, processed, queried, browsed, or otherwise manipulated and displayed. Table 7 is especially relevant in this context.

The manner in which the purchaser provides criteria regarding the purchaser goods/services can be provided to the Online Sports system, where it can be stored, processed, queried, browsed, or otherwise manipulated and displayed, can be of any variety. Examples include (i) providing a written description of the goods/services on an online Sports system web page; (ii) transmission of a file including the information; (iii) reference to a web page URL including the information.

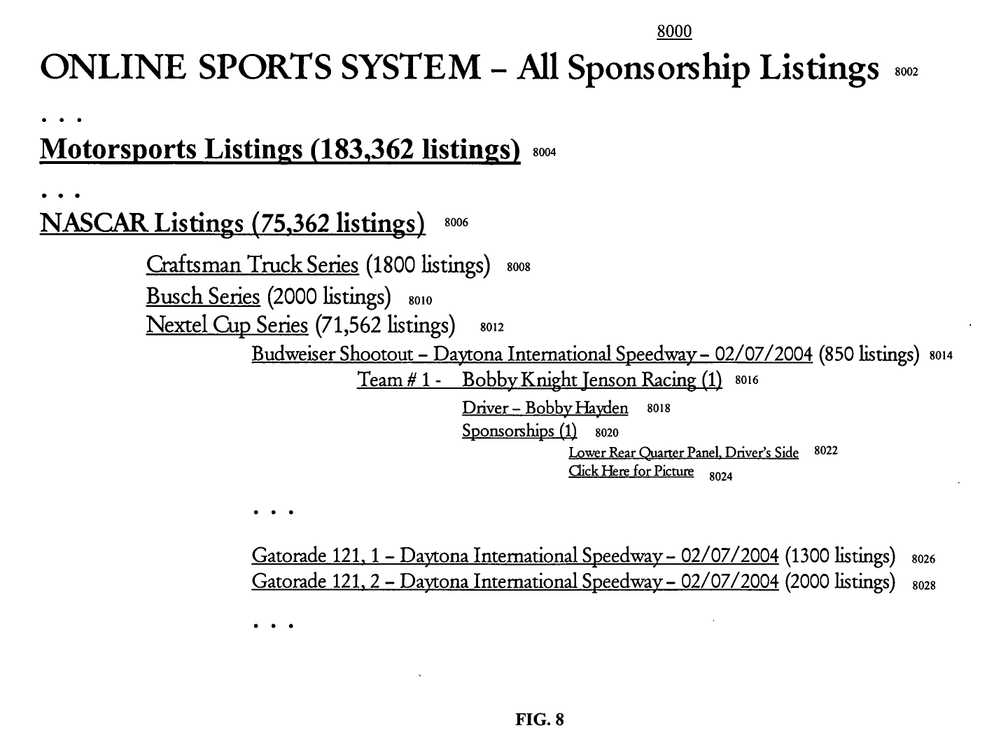

The manner of displaying the goods/services can take any format as well. For example, FIG. 8 illustrates Online Sports system listings for the specific embodiment of purchase and selling of sponsorship positions between sponsorship seller user entities and sponsorship purchaser user entities. The structure shown is a hyperlinked structure, wherein within each level of the structure, there are deeper, sub-levels. Each level shows a number next to it in parentheses, which is the total number of listings on the system under the particular practice level.

Specifically, FIG. 8 shows a comprehensive list 8002 of all sponsorships offered through the Online Sports system, based on the types of sports. Of the 183,362 motorsports sponsorship listings 8004, there are 75,362 NASCAR sponsorship listings 8006.

Within NASCAR listings, there are 1,800 sponsorship listings for the NASCAR Craftsman™ Truck Series 8008, 2,000 sponsorship listings for the NASCAR Busch™ Series 8010, and 71,562 sponsorship listings for the NASCAR Nextel™ Cup Series 8012.

By clicking on the NASCAR Nextel™ Cup Series hyperlink 8012, the purchaser user entity (or any other user entity) is hyperlinked to a list of races wherein sponsorship are offered by teams. The first race listed is the 02/07/2004 Budweiser™ Shootout race 8014, hosted at the Daytona International Speedway. There are 850 sponsorship listings for this race, meaning that 850 unique sponsorship opportunities are offered by different racing teams at this race. Additional races Gatorade 121, 1 8026 and Gatorade 121, 2 8028, featured on the same day at the same racetrack are also illustrated, among the many that can be listed.

By clicking on the 02/07/2004 Budweiser™ Shootout race, the purchaser user entity (or any other user entity) is hyperlinked to a list of race teams offering sponsorship at this race. The first racing team listed is Bobby Knight Jenson Racing 8016, which offers a single sponsorship opportunity. By successive hyperlinking, the user can determine any relevant information regarding the team or the sponsorship opportunity 8020. In the particular example illustrated, the sponsorship opportunity 8020 is for a racing vehicle operated by Bobby Hayden 8018, for the location known to skilled artisans as the “lower quarter panel, driver's side” of the racing vehicle 8022, whose position can be displayed by hyperlinking field 8024.

In one or more embodiments, any user entity can set any fields accessible by the Online Sports system. For example, a similarly laid out hyperlinked level-by-level structure can be implemented for listings of used automotive racing parts offered by racing teams.

Any user entity can search, query, browse, any categories relating to the goods/services or other relevant criteria, whether using information resident in the Online Sports system, or using external information.

F. Online Agreement

In these embodiments, user entities are permitted to establish online agreements with one another. For example, a sponsorship purchaser user entity is permitted to assent to a buy-sell agreement with a sponsorship seller user entity, or a goods purchaser user entity is permitted to assent to a buy-sell agreement with a goods seller user entity. Any type of legally binding contractual relationship or non-legally binding engagement can be mutually agreed to by the parties, which will establish a buyer-seller relationship.

Communication information can be provided to and gathered from the entity, for example at his/her browser 404, and stored, maintained, uploaded, downloaded, and processed on the Online Sports system. In these embodiments, the communication information is processed and maintained by the engagement conditions AS 518 and DS 520.

The terms and conditions can be previously prepared terms and conditions for an agreement, as found in many types of buy-sell agreements. A brief, non-exhaustive list of exemplary terms and conditions is found in Table 4.

TABLE 4
BUY-SELL AGREEMENT

PREAMBLE
IDENTITY OF SELLER
IDENTITY OF PURCHASER
DESCRIPTION OF GOODS/SERVICES
FEES/PAYMENT SCHEDULE
WARRANTIES/INDEMNIFICATION
MISCELLANEOUS TERMS AND CONDITIONS

In one embodiment, the purchaser and/or seller can mutually assent to engagement conditions provided over a GUI interface in their respective browsers 404, 408. The engagement process can be begun by either user entity, with the other user entity being notified of the first user entity's preferences and having a chance to either agree to the engagement conditions, or making changes to the conditions. In this embodiment, the process toggles back and forth, until both parties agree to the engagement conditions.

For example, initially a purchaser entity can be shown a GUI interface including terms and conditions, with the purchaser entity having one or more options to choose from on the GUI interface. The GUI can include numerous default settings, making the decision making process simpler for the purchaser, or “standard” to buy-sell agreements used throughout a particular community, geographical region, or jurisdiction. Upon the purchaser's “checking off” the desired choices, a message is transmitted to the seller chosen by the purchaser, which will include a hyperlink to the terms and conditions, including the values preselected by the purchaser. The seller can then choose to agree to all the terms and conditions desired by the purchaser, whereupon notification of acceptance is transmitted to the purchaser, or the seller can instead choose to change one or more of the terms and conditions, whereupon notification of an agreement with changed conditions is transmitted to the purchaser.

Upon receipt of seller's acceptance of the purchaser's terms and conditions, the purchaser can choose to acknowledge and verify his/her acceptance of the agreement. On the other hand, upon receipt by purchaser that the seller has changed one or more of the terms and conditions, the purchaser can choose to agree to the changed conditions or refuse acceptance. Once again, the seller is made aware of the purchaser's decision, and is given the opportunity to respond once again.

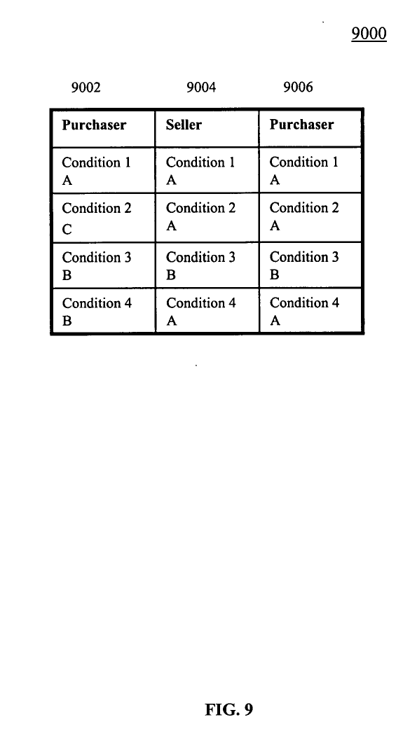

FIG. 9 provides an exemplary illustration of the above-described toggle method. Initially, the purchaser chooses conditions 9002, including engagement condition 1 as A, engagement condition 2 as C, engagement condition 3 as B, and engagement condition 4 as B. Next, the seller is given notice of the purchaser's preferred engagement conditions, and chooses conditions 9004, including engagement condition 1 as A (agreement with purchaser condition), engagement condition 2 as A (disagreement with purchaser condition), engagement condition 3 as B (agreement with purchaser condition), and engagement condition 4 as A (disagreement with purchaser condition). Next, the purchaser is given notice of seller's responses to his/her preferred engagement conditions, and notices that the seller has agreed to engagement conditions 1, 3, but has disagreed with conditions 2, 4. At this point, the purchaser chooses to agree to the changes proposed by the seller, and verifies acceptance of conditions 1-4.

Any user entity can search, query, browse, any categories relating to the engagement conditions method, whether using information resident in the Online Sports system, or using external information.

G. Online Communication

In these embodiments, users, including the aforementioned entities are provided facilities with which to communicate with one another. This communication can occur at any point, including before an online agreement between a seller user entity and a purchaser user entity. The communication can be between any types of entities, for example, between two purchasers, between a seller and a purchaser, between two sellers, etc.

Any type of online communication can take place. Communications network 120 provides wireline communications capability, wireless communications capability, or a combination of both, at any frequencies, using any type of standard, protocol or technology. The applications can be of any type as well, including message threads, chats, and streaming video such as webcasts, to name a few. As used herein, threads refer to bulletin board systems (BBSs), related newsgroups, or e-mail messages, or the like, on a subject, including an original message and subsequent replies.

Newsgroups are, for example, an electronic discussion group with collections postings or articles that are related on a given topic. The postings are posted to news servers that distribute them to other participating servers. BBS as used herein is a system permitting individuals to read one another's messages and post their own messages, with the Usenet being the largest distributed BBS in the world.

Email as used herein refers to electronic mail, comprised of messages, including text, figures, web pages, sent between individual users. Chat as used herein refers to “real time” communication over the Internet, though in general individuals performing online chat type messages to one another and a message appears on the screen of individual being communicated with. It is possible to compartmentalize chats between different users based on mutual interests in what are called chat rooms.

Video streaming as used herein refers to downloading of videos and other content from servers and viewed on the sponsorship purchaser user entity's browser. Webcasting as used herein refers to video streaming to user entities at a rate that matches their network connection speeds, permitting each user to watch the content as it arrives.

Communication information is provided to and gathered from the user entity, for example at his/her browser 404, 408, and stored, maintained, uploaded, downloaded, and processed on the Online Sports system. In these embodiments, the communication information is processed and maintained by the online communication AS 522 and DS 524.

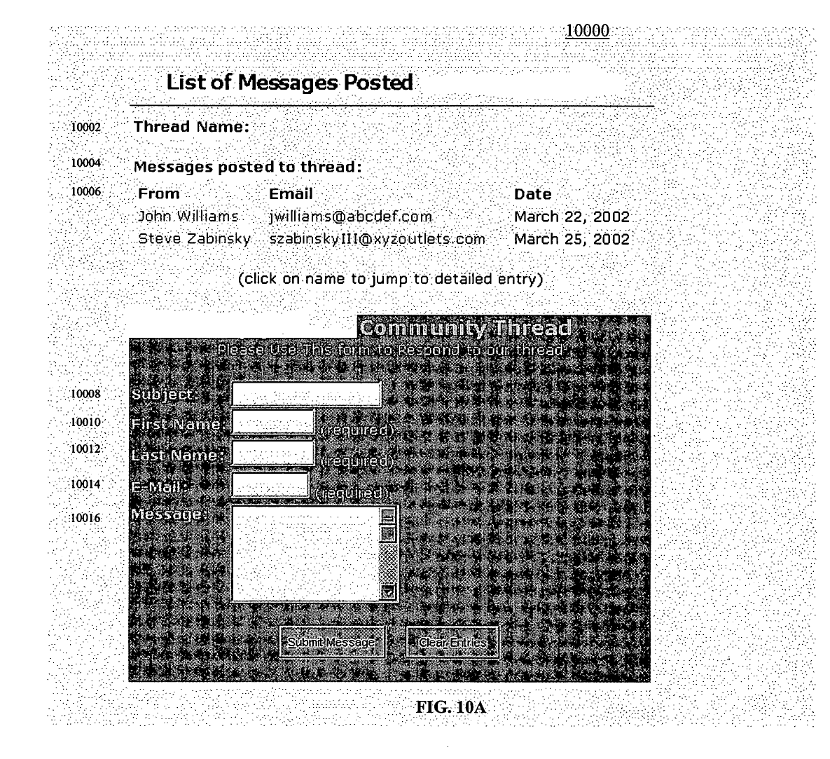

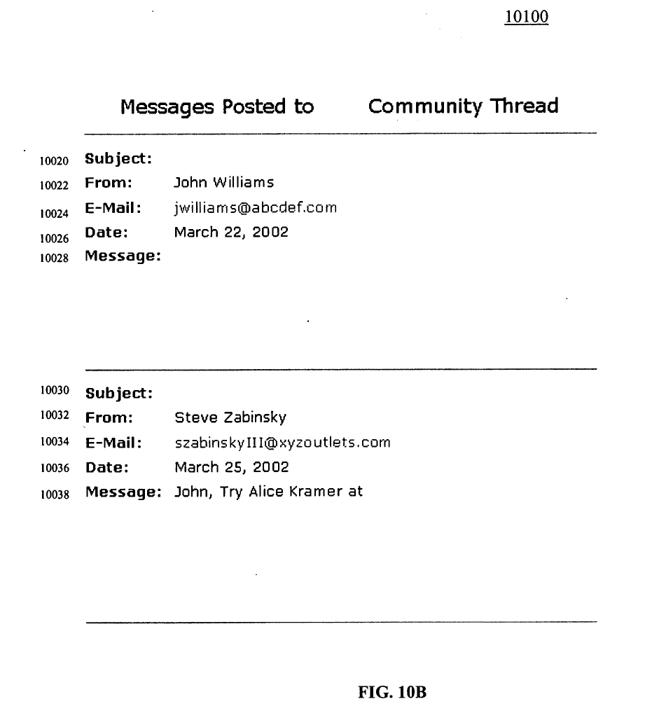

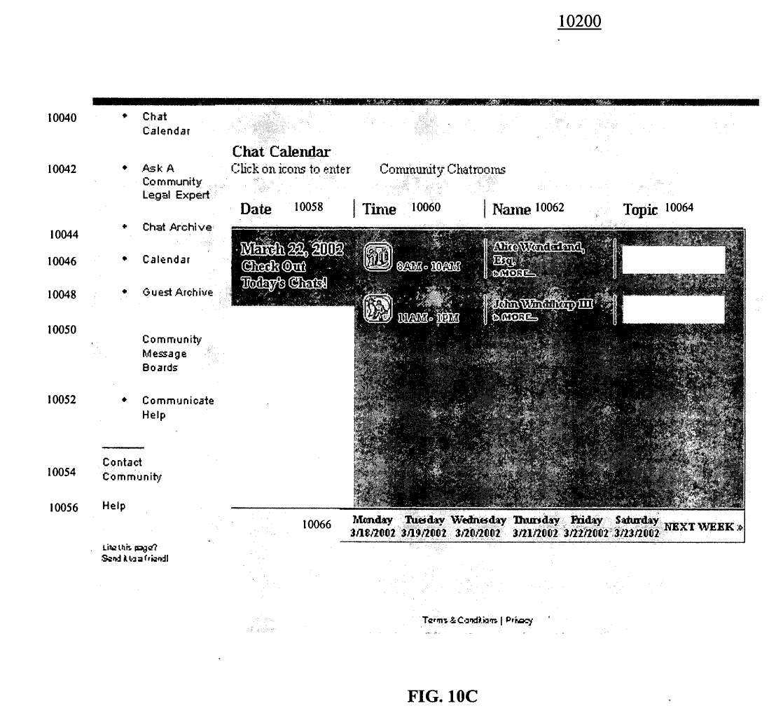

FIG. 10A illustrates an exemplary web page GUI for a discussion thread, specifically messages posted to the Online Sports system. Illustrated are information fields relating to a thread regarding the search for sporting goods, including the thread name 10002, messages posted to the thread 10004, and information fields 10006 showing who posted the thread, the person's e-mail address, and the date the thread was posted. John Williams has posted a first thread on the subject on Mar. 22, 2002, and Steve Zabinsky has posted a second thread on Mar. 25, 2002. A user entity can post his or her own thread in response to the subject (shown as subject 10008) by filling in their first name 10010, last name 10012, e-mail (or Online Sports system userid or ID) 10014, and message 10016.

FIG. 10B illustrates the content of the threads originally posted, including for John Williams, subject field 10020, from field 10022, e-mail field 10024, date field 10026, and message field 10028, and for Steve Zabinsky, subject field 10030, from field 10032, e-mail field 10034, date field 10036, and message field 10038.

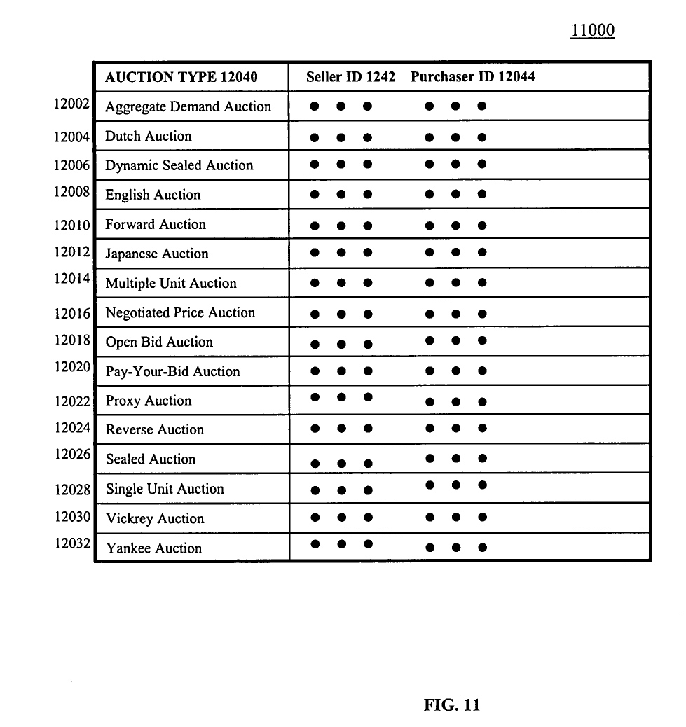

FIG. 11C illustrates an exemplary web page GUI for chat discussions, for example, messages posted to the Online Sports system. Illustrated is what a user entity views when he or she clicks on a chat calendar hyperlink 10040 on the left of the webpage. Included are the dates that chats will be conducted and monitored 10058, the times 10060, the persons Online Sports system members can chat with 10062, the topics for discussion 10064, and a hyperlink to other days 10066.

Also illustrated are hyperlinks to additional services that that can be processed and maintained by the online communication AS 522 and DS 524. Included are ask an Online Sports system expert hyperlink 10042 (which permits user entities to conduct threads and/or chats with known sports industry experts), chat archive hyperlink 10044 (which permits user entities to view archives of previous chats), a calendar hyperlink 10046 (which permits user entities to maintain their own personalized calendars for chats and discussion threads), a guest archive hyperlink 10048 (which permits a user entity to view previous Online Sports system guests for chats and/or threads), Online Sports message boards hyperlink 10050 (which permits a user entity to post or see threads, as illustrated in FIGS. 11A, 11B), communicate help hyperlink 10052 (which provides user entities instructions for communicating online in the Online Sports system), contact Online Sports hyperlink 10054 (for connecting user entities to individuals who run the Online Sports system), and help hyperlink 10056 (which provides user entities help regarding the Online Sports system).

In one or more embodiments, a web page GUI permits user entities to hear, see and transmit radio and video feeds, for example, radio and video feeds that can be downloaded from the Online Sports system. When a user entity clicks on a radio and video calendar hyperlink on a webpage, the viewer can download radios and videos feeds.

Any user entity can search, query, browse, any categories relating to the online communication method, whether using information resident in the Online Sports system, or using external information.

H. Fee Arrangements

In these embodiments, a party who desires to receive goods/services (for example, a sponsorship purchaser user entity) and goods/services provider (for example, a sponsorship seller user entity) can offer one another and mutually agree to a fee arrangement. Any type of fee arrangement is permitted and anticipated, including standard fee arrangements, alternative fee arrangements and online auctions. The information provided can be internal to the Online Sports system or extracted from information external to it. For example, this information can help a purchaser user entity determine whether to engage the services of a seller user entity.

The aforementioned information can be extracted from, for example, seller user entities, using their browsers 404, with the information being stored, maintained, uploaded, downloaded, and processed on the Online Sports system, and processed and/or displayed for the purchaser user entity at his/her browser 408. In these embodiments, processing and maintaining of the information is performed by the billing method AS 526 and DS 528.

Standard fee methods that can be employed include fixed fee, contingent fee, hourly fee, and retrospective based on value arrangements. Fixed fee is valuable where the goods/services can be easily and precisely defined, so that the scope of engagement may be foreseen by the user entities with some amount of certainty. In a contingent fee arrangement, a portion or all of the fee paid to seller user entities is based on the results obtained by the purchaser user entity. In hourly fee, the basis for payment is purely on the number of hours spent by the seller user entities in performing the purchaser user entity's services or providing the purchaser goods. In a retrospective based on value arrangement, the fee is determined somewhat subjectively through mutual cooperation between and subjective evaluation of the user entities after the purchaser user entity's services have been performed or goods have been provided.

In a number of embodiments, the services rendered or goods provided are determined and performed based on an online auction basis. In one or more embodiments, the goods/services are provided through auctions and/or fixed pricing through the online marketplace community known as eBay,™ where the buyers (for example, sponsorship purchaser user entity or goods purchaser user entity) and sellers (for example, sponsorship seller user entity or goods seller user entity) described herein are eBay™ users, participating in eBay™ auctions and/or fixed price sales.

However, the present invention is not limited to eBay™ auctions and can be used with respect to any online system or auction. In fact, the present invention can be used for non-auction based websites, and through the technologies described herein, including through any of the aforementioned types of devices, for example wireline or wireless devices.

There are two general embodiments for each type of auction. (i) The first general embodiment is where the purchaser user entity (for example, the sponsorship purchaser user entity or goods purchaser user entity) bids on goods/services offered by the seller user entity (for example, the sponsorship seller user entity or goods seller user entity) on the Online Sports system. (ii) The second general embodiment is where the seller user entity (for example, for example, the sponsorship seller user entity or goods seller user entity) bids on goods/services offered by a purchaser user entity (for example, the sponsorship purchaser user entity or goods purchaser user entity) offered on the Online Sports system.

Any type of auction known or anticipated by skilled persons can be held. It is important to note that any of the information available on the Online Sports system can be used in the auction process.

In one or more embodiments, the goods/services posted by purchasers and bid upon by seller user entities includes the universal projects, projects, and tasks listed in Table 7, including any sub-categories or other characteristics thereof, whether offered by a single or group collaboration of purchaser user entities or other recipient user entities. In one or more embodiments, goods/services posted by sellers and bid upon by purchasers, via standard fee arrangements, alternative fee arrangements, whether described herein or known to skilled persons, including any sub-categories or other characteristics thereof, whether offered by a single or group collaboration of seller user entities or other provider user entities. The aforementioned comments apply to any of the auctions mentioned in Table 5 or known to skilled persons.

FIG. 11 illustrates a non-exhaustive list of auction types, understood by skilled artisans, that can be used in the present invention. The auction types 11040 can be indexed, for example, based on any user entity identification information. The identification information illustrated include seller user entity userid 11042, and purchaser user entity userid 11044. The exemplary auction types 11040 that are shown include: aggregate demand auction 11002, Dutch auction, 11004, dynamic sealed auction 11006, English auction 11008, forward auction 11010, Japanese auction 11012, multiple unit auction 11014, negotiated price auction 11016, open bid auction 11018, pay-your-bid auctions 11020, proxy English auction 11022, reverse auction 11024, sealed auction 11026, single unit auction 11028, Vickrey auction 11030 and Yankee auction 11032. Table 5 provides a listing of the aforementioned auction types used in the present invention.

TABLE 5
AUCTION TYPE

Aggregate Demand Auction
Dutch Auction
Dynamic Sealed Auction
Forward Auction
English Auction
Japanese Auction
Multiple Unit Auction
Negotiated Price Auction
Open Bid Auction
Pay-Your-Bid Auctions
Proxy Auctions
Reverse Auction
Sealed Auction
Single Unit Auction
Vickrey Auction
Yankee Auction

In addition to and corresponding to the type of fee arrangement, the goods/services seller user entity and the goods/services purchaser user entity can mutually agree to any know terms and conditions, including for example, how expenses are itemized and billed, and which expenses may be billed separately

In addition to the aforementioned standard fee arrangement, any type of alternative fee arrangement can be agreed to by the seller user entities and the purchaser user entities.

Any user entity can search, query, browse, any categories relating to the billing method, whether using information resident in the Online Sports system, or using external information.

I. Banking

In these embodiments, users, including the aforementioned entities are provided facilities with which to bill one another for services rendered and receive payments.

Not only can sponsorship providers, for example seller user entities, receive payments using the system, but so can purchaser user entities, third parties (or third party user entities), including the proprietors of the Online Sports system, or third parties used by the Online Sports system in rendering services.

Any of such parties can receive payments from another party on or using the Online Sports Services system. Exemplary methods for charging and collecting fees on the Online Sports system include (i) a flat fee, paid before the first usage of the Online Sports system; (ii) a flat fee paid periodically, for example, for daily, weekly, monthly, yearly usage of the Online Sports system; (iii) an escalating fee structure that escalates upon usage, or a de-escalating fee structure that de-escalates upon usage, whether over lifetime usage of the Online Sports system, or periodically, for example, upon daily, weekly, monthly, yearly usage of the Online Sports system; (iv) a transactional fee structure, where user entities who receive services (for example, legal services) are charged per transaction; (v) an advertising and/or sponsorship model structure, where advertisers and sponsors of the Online Sports system pay for being awarded the opportunity to target user entities for advertising, and either third parties, goods/services seller user entities, or goods/services purchaser user entities receive such payments; (vi) a direct marketing model, where any information gathered from user entities by the Online Sports system is sold to individuals or companies who wish to directly target such user entities for advertising, and the payment is received by third parties or user entities using the Online Sports system; (vii) a hybrid model, which mixes one or more of the above-noted fee structures; and (viii) any other fee models recognized by skilled persons.

Any online mechanisms can be used for the aforementioned advertising and sponsorship revenue models. Table 6 includes a few exemplary revenue models, along with useful ecommerce terms. Any of these revenue models, together with any others known or anticipated by skilled persons can be used with the present invention.

TABLE 6

| ECOMMERCE | |
|---|---|
| TERMS | DESCRIPTION |
| Banner | Banner is a rectangular graphic element used for advertising on a web |
| | page, which encourages a Click-through by a user entity or other user. |
| Click-streams | Click-stream is an electronic path a user entity or other user follows |
| | during navigation between pages within a website, or between different |
| | web sites, which can be measured to determine advertising revenues. |
| Click-through | Click-Through is the clicking on an advertisement on a web page (for |
| | example, a banner ad) to link to the advertiser's web page or website. |
| | Click-through are one way to measure advertising revenues. |
| Click-Through | Click-Through Rate (CTR) is the rate of click-throughs, or advertisement |
| Rate (CTR) | response rate, usually calculated by dividing the number of click- |
| | throughs that an ad has received by the number of impressions, and |
| | multiplying by 100 to get a percentage. |
| Cost Per Action | Cost Per Action (CPA) refers to the cost to an advertiser for every |
| (CPA) | particular action, taken by user entities or other users, in response to an |
| | advertisement. The action can be a full sale, a sales lead, every time a |
| | potential customer submits certain information, the successful download |
| | of a software program, etc. |
| Cost Per Click | Cost Per Click (CPC) refers to the cost to an advertiser for every link |
| (CPC) | from an advertisement (for example, banner ad) to the advertiser's web |
| | page or website. |
| Cost Per Sale | Cost Per Sale (CPS) is the price paid by an advertiser to another site for |
| (CPS) | each sale that resulting from a visitor referred from the site to the |
| | advertiser's site. One way of tracking CPS is via cookies, applications |
| | stored on the user's computer. |
| Cost Per | Cost Per Thousand (CPM, using Roman numeral notation) refers to the |
| Thousand (CPM) | cost to an advertiser for every 1,000 impressions provided to his or her |
| | advertisement (for example, banner ad) on another site. |
| Demographics | Demographics refers to the measurement of demographic data to permit |
| | population segmentation, include by age, gender, income and location. |
| GIF | GIF is the most common compression format for banner advertisements |
| | and most others. Animated GIF is an animation created by combining |
| | multiple GIF images into one file, which is displayed to resemble |
| | movement. |
| Gross Exposures | Gross Exposures/Gross Impressions: The total number of times an ad is |
| or Gross | shown, including duplicate showings to the same person. |
| Impressions | |
| Hits | Hits refers to the fact that every time a file is sent by a server, be it text, |
| | graphic, video and so on, it is recorded as a hit. Not a reliable gauge to |
| | compare different sites, as one page with five graphic elements will |
| | register six hits when viewed, while a page with no graphics will only |
| | register one hit. |
| Impression | Impression refers to the Opportunity To See (OTS) of an advertisement. |
| Inventory | Inventory refers to the amount of available space for banners on a web |
| | site that can be delivered in a given time period. It is also used to refer to |
| | the number of gross impressions per month, or clicks if the CPC model is |
| | used. |
| Opportunity-To- | Opportunity To See (OTS) is when the user entity or other user is given |
| See (OTS) | the opportunity to view the impression. Although a Page-View is an |
| | OTS, an impression is not so, because the advertisement can be located at |
| | the bottom of the web page, which will not be seen unless the user scrolls |
| | down. |
| Page-View | Page-View is when a user entity or other user uses his or her browser to |
| | requests a web page, which is often used for tracking of impressions. |
| Popup Window | Pop-Up Windows are web pages that pop up between the user entity or |
| (or Interstitial | other user and what the viewer is viewing or expecting to view. |
| advertisement) | |
| Psychographics | Psychographics refers to measurement of psychological characteristics |
| | from user entities or other users to allow for segmentation of the |
| | population. Examples include retrieving information on lifestyle, |
| | purchasing behavior, attitudes. |
| Pull | Pull refers to any technology or tools that are available to the user entity |
| | or other user passively, meaning that they must visit the website and |
| | retrieve the information for themselves. |
| Push | Push refers to any technology or tools that deliver information to a user |
| | entity or other user, for example at their browser. |
| Reach | Reach is the total number of user entities or other users who will see an |
| | advertisement. |
| Sell-Through Rate | Sell-Through Rate is the percentage of advertisements sold, not bartered |
| | or traded through an advertisement network. |
| Session | Session refers to a full web site visit by a user entity or other user. |
| Sponsorship | Sponsorship is an online marketing program between a website publisher |
| | and an online advertiser designed to create the appearance that there is a |
| | close connection between the two companies. Instead of simple |
| | advertisement banner displays, a campaign can be created to blur the |
| | distinction between editorial content and promotion. In one or more |
| | embodiments, a user entity or a third party can sponsor web pages on the |
| | Online Sports system to provide advertising for themselves, and to |
| | provide fees for the proprietors of the Online Sports system, third parties, |
| | or other user entities. |
| Traffic | Traffic refers to the number (and possibly types) of user entities or users |
| | visiting the site. |

The fee information is provided to and gathered from the entity, for example at his/her browser 404, 408, and stored, maintained, uploaded, downloaded, and processed on the Online Sports system. In these embodiments, the fee features are processed and maintained by the billing method AS 526 and DS 528.

In the present invention, the manner in which fees are presented and paid can occur by any method recognized by skilled artisans. Two categories are (i) traditional fee presentment and payment and (ii) electronic bill presentment and payment (EBPP).

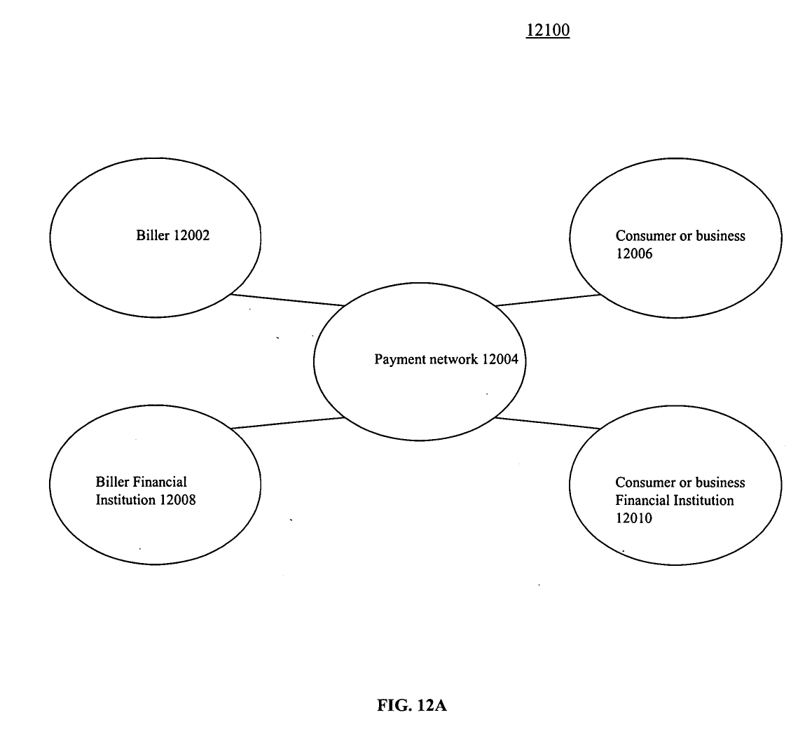

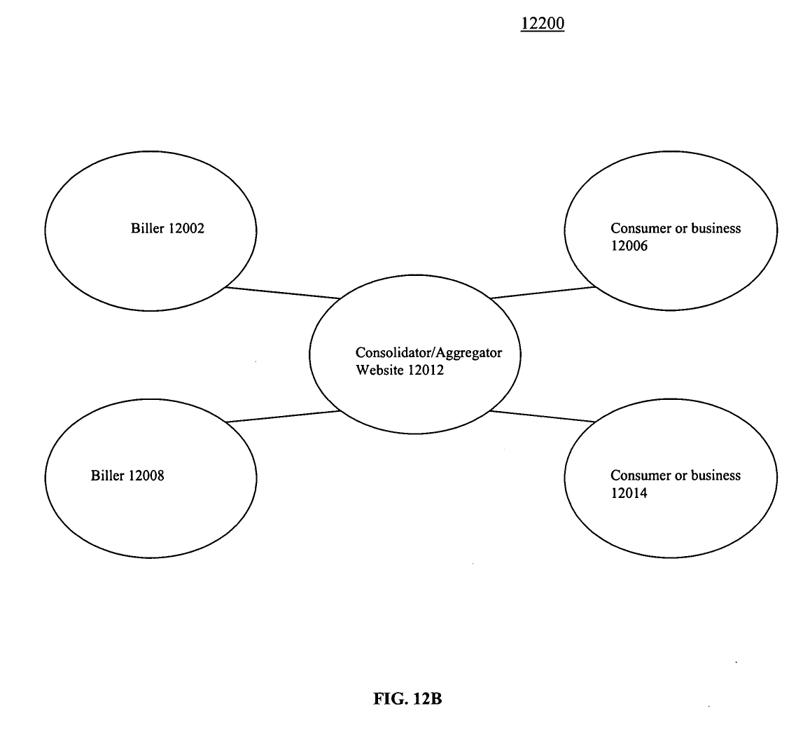

FIG. 12A illustrates an exemplary manner in which both types of bill presentment can occur. FIG. 12A includes biller 12002, consumer or business 12006, payment network 12004, biller financial institution 12008, and consumer or business financial institution 12010.

Biller 12002 is the party who bills another party for the services rendered. For example, biller 12002 can be a user entity on the Online Sports system, such as a sponsorship seller user entity, who provided services. Biller 12002 notifies consumer or business 12006 that a payment is due.

Consumer or business 12006 is the party who receives the notice that a bill is due from biller 12002. Consumer or business 12006 can be a user entity on the Online Sports system, such as a sponsorship purchaser user entity, that has received the services. In response to the notice that a bill is due, consumer or business 12006 directs that a payment be made.

When consumer or business 12006 directs a payment, the consumer or business financial institution 12010 makes a payment, through payment network 12004, to the biller financial institution 12008. In response, the biller financial institution 12008 makes the requested payment to biller 12002.

However, the model for bill payment can be much more intricate, with many more players, as skilled persons will recognize. It is possible that the consumer or business 12006 will request that payments be made through one or more intermediaries, each with their own financial institutions to make payments as directed, through the payment network 12004.

As one example, (i) a consumer or business 12006, which is a services/goods purchase user entity (for example, a sponsorship purchaser user entity) directs that a payment be made to the Online Sports system, causing the consumer or business financial institution 12008 to make a payment to the financial institution of the Online Sports system. The Online Sports system can keep a set percentage of the payments made, and direct that a payment be made to a third party consolidator service, causing the financial institution of the Online Sports system to make a payment to the financial institution of the third party consolidator service. The third party consolidator service can then keep a set percentage of the payments made to it from the Online Sports system, and in turn direct that a payment be made to biller 12002 (for example, a sponsorship seller user entity), causing the financial institution of the third party consolidator service to make a payment to the biller financial institution 12008.

In the present invention, EBPP can occur in any known manner. Examples include a biller-direct method, a consolidation/aggregation model, and an alterative consolidation/aggregation model.

In the biller-direct method, the biller 12002 generates an electronic copy of the consumer or business billing information upon registration by the consumer or business 12006. The biller tasks can also be outsourced by the biller 12002 to a bill sponsorship provider (BSP), which provide such services as electronic bill translation, data parsing, formatting and hosting the website for the biller. Upon notification of a bill due (by such sources as e-mail), the consumer or business 12006 logs onto the website of the biller 12002 (or BSP), where the consumer or business 12006 is shown an electronic version of the billing statement, for example in a browser 408. Upon viewing the billing statement online, consumer or business 12006 makes a payment online.

In one embodiment, the consumer or business 12006 is a goods/services purchaser user entity, and the fields shown to the goods/services purchaser user entity are collected from him or her and are any or all of the fields described above and illustrated with reference to FIGS. 6A-6E. A variety of other known login information, passwords, and security encryption algorithms can be used instead, as recognized by skilled persons.

In the consolidator/aggregation method, the biller 12002 transmits the billing information for the consumer or business 12006 to a third party consolidator/aggregation service. The third party consolidator/aggregation service will receive and combine the billing information for many billers 12002. The third party consolidator/aggregation service provide the services of electronic bill translation, data parsing, formatting and hosting on its own website, or can outsource this function to a consumer sponsorship provider (CSP), such as an Internet portal, broker website, or a financial institution.

FIG. 12B illustrates an exemplary manner in which the present invention can use a consolidation/aggregation service. FIG. 12B includes biller 12002, a second biller 12008, consumer or business 12006, a second consumer or business 12014, and a consolidation/aggregation service website 12012. Upon notification of a bill due (by such sources as e-mail), a consumer or business 12006 logs onto the consolidation/aggregation service website 12012, where the consumer or business 12006 is shown an electronic version of the billing statement, for example in a browser 408. Upon viewing the billing statement online, consumer or business 12006 makes a payment online.

In the present invention, the consolidator/aggregation method can be used with any known or anticipated standards, including Open Financial Exchange (OFX), which uses HTML, and Interactive Financial Exchange (IFX), which uses XML.

In the alternative consolidator/aggregation method, the above-noted consolidator/aggregation method is employed, with variations in the manner in which the bill is created or delivered. In one embodiment, screen scraping is used to capture information from the websites of multiple billers 12002, using user entity userids and passwords, which are then presented at another website, for example, at the screen scraper's website, or at a CSP website. In one embodiment, total bill consolidation is used, where a user entity is permitted to view and pay all of his or her bills, at a single Internet point or website. In one embodiment, consumer consolidation is used, where electronic bills are delivered to the desktop of the user entity, from which payments can be made. In one embodiment, e-mail consolidation is used, where electronic bills are delivered to a user entity via e-mail, from which payments can be made.

In the present invention, a user entity can employ any known or perceived payment mechanism and network when utilizing the EBPP process. An exemplary list of account mechanisms and networks include: Automated Clearinghouse (ACH), Electronic Fund Transfers (EFTs), Debit cards, Credit cards, Automated Teller Machines (ATMs), Automatic Transfer Service (ATS), Bankwire, Check Clearing, Clearinghouse, Clearinghouse Interbank Payments System (CHIPS), Fedwire, Federal Reserve Float, FRCS-80, Regional Check Processing Center (RCPC), and Swift.

Any user entity can search, query, browse, any categories relating to the banking method, whether using information resident in the Online Sports system, or using external information.

J. Progress Management

In these embodiments, the present invention permits purchasers to assign service tasks to sellers, who perform the work. For example, in the arena of sports, potential purchasers can order and pay for particular performances by sports teams or players. In the world of motorsports, for example, it is possible for a client (purchaser) to pay for a motorsports team to provide show car appearances at local stores and outlets to engage fan support, and thereby expand local sales.

In these embodiments, the user entities are provided the opportunity to monitor and administer the progression of tasks. For example, a services purchaser user entity is provided the opportunity to monitor the status of his or her tasks as provided by a seller user entity.

The monitoring of work progression can include the monitoring of any features of tasks/work performed by one user entity for another user entity. An exemplary list of these features is provided in Table 7, though skilled persons will recognize there are many other monitoring features that can be included as well, including the numerous data collected and processed from user entities, as described above.

For example, a purchaser user entity can receive the following information from his or her seller user entity: (i) a description of all projects, particular projects, particular tasks within a project, particular subtasks within a task, etc.; (ii) a listing of the manner in which the purchaser is billed for all projects, particular projects, particular tasks within a project, particular subtasks within a task, etc.; and (iii) a listing, either to-date, quarterly, or year-to-date, of the (a) billed and collected amounts, and (b) billed and uncollected amounts, for all projects, particular projects, particular tasks within a project, particular subtasks within a task, etc. Additionally, any of the foregoing features can be mutually agreed to, between the user entities. For example, the description of all projects, particular projects, particular tasks within a project, particular subtasks within a task, etc. can be mutually agreed to.

As another example, a purchaser user entity can provide a satisfaction rating, which is a description or numerical rating regarding (i) the quality of the tasks/work product (for example, either a numerical rating or description), and (ii) the reasonableness of billing amounts, for all projects, particular projects, particular tasks within a project, particular subtasks within a task, etc. (for example, either a numerical rating or description).

In addition, any or all of the aforementioned features can be shared with other members of the Online Sports system. This can occur at various security levels, so that some individual user entities or groups of user entities can be permitted access to one or more features, whereas others are not permitted access. Examples of groups with differing security levels can include, for example, groups based on sports areas, industry areas, geographical areas, or user entity interests. In one embodiment, any entities or groups of entities (for example, (i) the Online Sports system, itself, (ii) groups of user entities, or (iii) individual user entities) can permit access to any features on the system at any variable security levels, to the same or other groups of user entities. For example, a purchaser user entity and a seller user entity (performing tasks/work for the purchaser user entity) can mutually agree to provide all other purchaser user entities access to (i) the description of the tasks/work performed on a particular project, (ii) the amounts billed and collected from the purchaser user entity, and (iii) the satisfaction level of the purchaser user entity with the work of the sponsorship seller user entity.

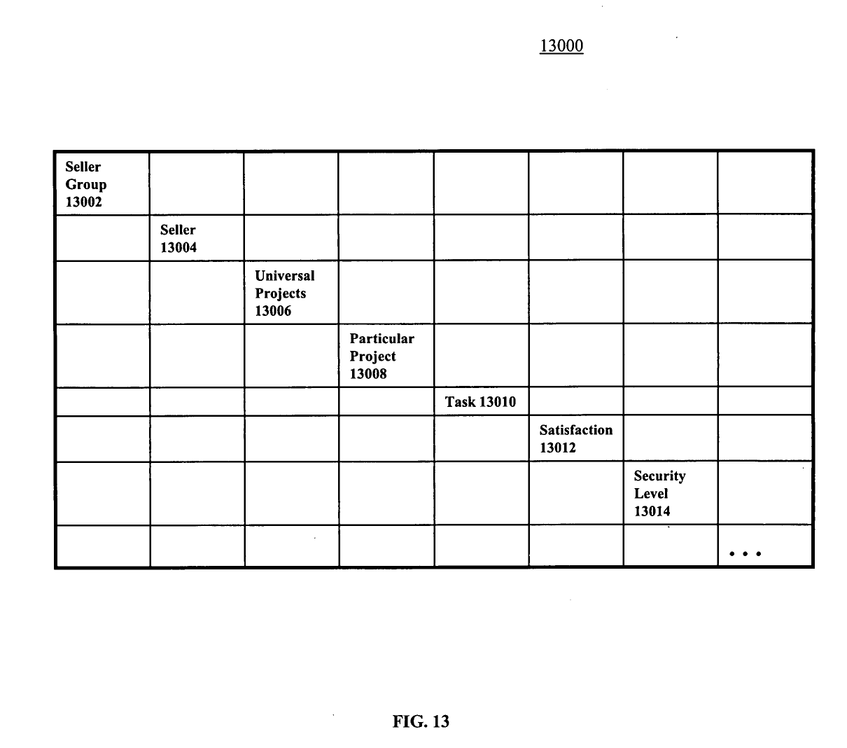

FIG. 13 is a conceptual diagram illustrating an object oriented, or multilevel view, of the progress management features described. A purchaser user entity engages a corporation (group of sellers) 13002 to perform the purchaser client's work. Within the group of sellers user entity 13002 is a seller user entity 13004 who accomplishes all work projects 13006 for the client purchaser. One particular project is project 13008, which includes a number of tasks, one of which is task 13010. Field 13012 is the satisfaction level for task 13010, which can be, for example, of the work quality, the amount billed, the friendliness and responsiveness of the seller service provider, etc., measured quantitatively or qualitatively, through a user-provided description or through predetermined means provided on the Online Sports system, each of which can be sublevels (not labeled) of the satisfaction level 13010. Lastly, one of the features associated with the satisfaction level is the security level 13014.

The features can be collected from user entities, processed, and displayed in any manner. Three exemplary manners are provided below. The first exemplary manner is through processing as already described with respect to online communication AS 522 and DS 524. For example, user entities can provide the information to one another through message threads, online chat, radio and video broadcasts.

The second exemplary manner is the processing of billing transactions as already described with respect to billing method AS 526 and DS 528, for the billing features mentioned. All of the billing methods described with references to AS 526 and DS 528 can be used to process, store and display features related to billing, and used in coordination with the features provided for progress management.

The third exemplary manner is through use of progress management AS 534 and DS 536. Progress management information is provided to and gathered from the entity, for example at his/her browser 404, and stored, maintained, uploaded, downloaded, and processed on the Online Sports system. In this third exemplary manner, work progress management is processed and maintained by the progress management AS 534 and DS 536. Accordingly, such features as provided in Table 7 and FIG. 13 are gathered from user entities, processed, and the processed information is displayed to other user entities.

TABLE 7

| SELLER-PURCHASER | |
|---|---|
| MANAGER FIELD | TASK DESCRIPTION |
| Purchaser Userid | The userid of the Purchaser on the Online Sports |
| | system. |
| Seller Userid | The userid of the Seller on the Online Sports system. |
| Seller Group Userid | The userid of the firm of the Seller on the Online |
| | Sports system. |
| Universal Projects Userid | A userid identifying the overall work efforts between |
| | the Purchaser and the Seller. |
| Universal Projects Description | An overall description of the work efforts between the |
| | Purchaser and the Seller. The description can be |
| | formulated by each entity individually (for example, by |
| | either the Seller or the Purchaser), or can be formulated |
| | by collaboration between them. |
| Universal Projects Updated | An updated version of the Universal Projects |
| Description | Description, which is formulated by each entity |
| | individually (for example, by either the Seller or the |
| | Purchaser), or can be formulated by collaboration |
| | between them. |
| Universal Projects Forecasted | The forecasted period of time Purchaser and/or Seller |
| Timetable | anticipated the universal projects would take to |
| | complete. |
| Universal Projects Actual | The actual period of time it is taking the Seller to |
| Timetable | complete the universal projects. A measure of how “on- |
| | track” Seller is in completing the universal projects. |
| Universal Projects Satisfaction | A quantitative or qualitative measure of the level of |
| Level | satisfaction by the Purchaser of the Seller performance |
| | for all projects. In one embodiment, other user entities |
| | of the Online Sports system are permitted access to the |
| | Universal Projects Satisfaction Level. |
| Universal Projects - Billing | The type of billing agreed to between the user entities. |
| Method | The billing methods used are described in detail with |
| | reference to billing method AS 526 and DS 528. |
| Universal Projects - Payment | The amount of forecasted payment for Universal |
| Amounts Forecasted | Projects, as agreed to by the user entities. For example, |
| | the forecasted payment agreed to by the Purchaser and |
| | the Seller, or by the Purchaser and the law firm. |
| Universal Projects - Payment | The amount of payments billed by Purchaser, and |
| Amounts Billed and Collected to | received by Seller and/or the firm for Universal |
| Date | Projects to date. |
| Universal Projects - Payment | The amount of payments billed by Purchaser, and not |
| Amounts Billed and Uncollected to | yet received by Seller and/or the firm for Universal |
| Date | Projects to date. |
| Universal Projects - Payment | The amount of payments billed by Purchaser, and |
| Amounts Billed and Collected for | received by Seller and/or the firm for Universal |
| the Quarter or for the Year-to- | Projects for the quarter, or year-to-date. |
| Date | |
| Universal Projects - Payment | The amount of payments billed by Purchaser, and not |
| Amounts Billed and Uncollected to | yet received by Seller and/or the firm for Universal |
| Date | Projects for the quarter, or year-to-date. |
| Projects Userid | A userid for a particular project, which is a |
| | subcomponent of the universal projects. |
| Projects Description | A description of a particular project. The description |
| | can be formulated by each entity individually (for |
| | example, by either the Seller or the Purchaser), or can |
| | be formulated by collaboration between them. |
| Projects Updated Description | An updated version of the Projects Description, which |
| | is formulated by each entity individually (for example, |
| | by either the Seller or the Purchaser), or can be |
| | formulated by collaboration between them. |
| Projects Forecasted Timetable | The forecasted period of time Purchaser and/or Seller |
| | anticipated the project would take to complete. |
| Projects Actual Timetable | The actual period of time it is taking the Seller to |
| | complete the project. A measure of how “on-track” |
| | Seller is in completing the project. |
| Projects Satisfaction Level | A quantitative or qualitative measure of the level of |
| | satisfaction by the Purchaser of the Seller performance |
| | for this particular project. In one embodiment, other |
| | user entities of the Online Sports system are permitted |
| | access to the Projects Satisfaction Level. |
| Projects - Billing Method | The type of billing agreed to between the user entities |
| | for this particular project. The billing methods used are |
| | described in detail with reference to billing method AS |
| | 526 and DS 528. |
| Projects - Payment Amounts | The amount of forecasted payment for this particular |
| Forecasted | project, as agreed to by the user entities. For example, |
| | the forecasted payment agreed to by the Purchaser and |
| | the Seller, or by the Purchaser and the law firm. |
| Projects - Payment Amounts | The amount of payments billed by Purchaser, and |
| Billed and Collected to Date | received by Seller and/or the firm for this particular |
| | project to date. |
| Projects - Payment Amounts | The amount of payments billed by Purchaser, and not |
| Billed and Uncollected to Date | yet received by Seller and/or the firm for this particular |
| | project to date. |
| Projects - Payment Amounts | The amount of payments billed by Purchaser, and |
| Billed and Collected for the | received by Seller and/or the firm for this particular |
| Quarter or for the Year-to-Date | project for the quarter, or year-to-date. |
| Projects - Payment Amounts | The amount of payments billed by Purchaser, and not |
| Billed and Uncollected to Date | yet received by Seller and/or the firm for this particular |
| | project for the quarter, or year-to-date. |
| Tasks Userid | A userid for a particular task, which is a subcomponent |
| | of a Project. |
| Tasks Description | A description of a task. The description can be |
| | formulated by each entity individually (for example, by |
| | either the Seller or the Purchaser), or can be formulated |
| | by collaboration between them. |
| Tasks Updated Description | An updated version of the Tasks Description, which is |
| | formulated by each entity individually (for example, by |
| | either the Seller or the Purchaser), or can be formulated |
| | by collaboration between them. |
| Tasks Forecasted Timetable | The forecasted period of time Purchaser and/or Seller |
| | anticipated the task would take to complete. |
| Tasks Actual Timetable | The actual period of time it is taking the Seller to |
| | complete the task. A measure of how “on-track” Seller |
| | is in completing the task. |
| Tasks Satisfaction Level | A quantitative or qualitative measure of the level of |
| | satisfaction by the Purchaser of the Seller performance |
| | for this particular task. In one embodiment, other user |
| | entities of the Online Sports system are permitted |
| | access to the Tasks Satisfaction Level. |
| Tasks - Billing Method | The type of billing agreed to between the user entities |
| | for this particular task. The billing methods used are |
| | described in detail with reference to billing method AS |
| | 526 and DS 528. |
| Tasks - Payment Amounts | The amount of forecasted payment for this particular |
| Forecasted | task, as agreed to by the user entities. For example, the |
| | forecasted payment agreed to by Purchaser and the |
| | Seller, or by the Purchaser and the firm. |
| Tasks - Payment Amounts Billed | The amount of payments billed by Purchaser, and |
| and Collected to Date | received by Seller and/or the firm for this particular |
| | task to date. |
| Tasks - Payment Amounts Billed | The amount of payments billed by Purchaser, and not |
| and Uncollected to Date | yet received by Seller and/or the firm for this particular |
| | task to date. |
| Tasks - Payment Amounts Billed | The amount of payments billed by Purchaser, and |
| and Collected for the Quarter or | received by Seller and/or the firm for this particular |
| sfor the Year-to-Date | task for the quarter, or year-to-date. |
| Tasks - Payment Amounts Billed | The amount of payments billed by Purchaser, and not |
| and Uncollected to Date | yet received by Seller and/or the firm for this particular |
| | task for the quarter, or year-to-date. |

Any user entity can search, query, browse, any categories relating to the progress management method, whether using information resident in the Online Sports system, or using external information.

### VIII. CONCLUSION

While various embodiments of the present invention have been described above, it should be understood that they have been presented by way of example only, and not limitation. Thus, the breadth and scope of the present invention should not be limited by any of the above-described exemplary embodiments, but should instead be defined only in accordance with the following claims and their equivalents.

What is claimed is:

1. An online sports system for providing one or more user entities using said system the ability to perform a sports related buying and selling related transaction, comprising:
(i) a communications network;
(ii) one or more nodes having associated processors, said nodes being interconnected via said communications network;
(iii) sports related transactions means for permitting a user entity using a first said node processor the ability to perform the sports related transaction, comprising:
(A) transmission of a sports related informational content to a second node processor from any one of: said first node processor; a third said node processor; a source external from said online sports system;
(B) processing of a said sports related informational content received by said second node processor in response to a request from said first node processor;
(C) receiving a result of said processing from said second node processor by said first node processor; and
(D) displaying said result of said processing by said first node.

2. An online sports system according to claim 1, wherein the sports related transaction means comprises one or more application servers and accompanying database servers.

3. An online sports system according to claim 1, wherein the sports related transaction relates to registration of the one or more user entities.

4. An online sports system according to claim 3, wherein the registration of the one or more user entities comprises any one of:
maintaining and updating one or more contents for a homepage;
extracting personal and professional information from the one or more user entities; and
having the one or more user entities agree to terms and conditions for using the online sports system.

5. An online sports system according to claim 1, wherein the sports related transaction relates to investigation and establishment of a relationship between provider user entities and recipient user entities.

6. An online sports system according to claim 5, wherein the provider user entities are seller user entities comprising any one of:
a National Association for Stock Car Auto Racing (“NASCAR”) motorsports racing team; and
one or more agents of a said NASCAR motorsports racing teams.

7. An online sports system according to claim 5, wherein the provider user entities are seller user entities, wherein the recipient user entities are purchaser user entities, wherein the investigation of provider user entities comprises:
soliciting personal information from said seller user entities for the benefit of said purchaser user entities; and
soliciting professional information from said seller user entities for the benefit of said purchaser user entities, and
wherein the investigation of recipient user entities comprises:
soliciting personal information from said purchaser user entities for the benefit of said seller user entities; and
soliciting professional information from said purchaser user entities for the benefit of said seller user entities.

8. An online sports system according to claim 7, wherein the sports related transaction is a sponsorship related transaction, the seller user entities are sponsorship seller user entities, and the recipient user entities are sponsorship purchaser user entities.

9. An online sports system according to claim 8, wherein the sponsorship related transaction is a transaction for the purchase and sale of sponsorship in the field of motorsports, wherein the sponsorship seller user entities are one of:
one or more motorsports racing teams; and
one or more agents of said motorsports racing teams, and
wherein the investigation of sponsorship provider user entities comprises soliciting or gathering information relating to any one of:
an identity of a said motorsports racing team;
an identity of a driver driving for a said motorsports racing team;
a relative size of sponsorship on a racing vehicle of a said motorsports racing team upon said motorsports racing team being engaged in one or more races;
a relative location of sponsorship on a racing vehicle of a said motorsports racing team upon said motorsports racing team being engaged in one or more races;
an identity of a racing series wherein a racing vehicle of a said motorsports racing team engages in a racing event;
an identity of a said racing event wherein a racing vehicle of a said motorsports racing team shall race;
an internal community reputation of a said motorsports racing team pertaining to a reputation of said motorsports racing team inside an online marketplace; and
an external community reputation of a said motorsports racing team pertaining to a reputation of said motorsports racing team outside an online marketplace.

10. An online sports system according to claim 8, wherein the sponsorship related transaction is a transaction for the purchase and sale of sponsorship in the field of motorsports, wherein the sponsorship purchase user entities are one of:
one or more legal entities desiring to obtain motorsports racing team sponsorship; and
one or more agents of said legal entities, and
wherein the investigation of sponsorship recipient user entities comprises soliciting or gathering information relating to any one of:
a name of a said legal entity;
an address of a said legal entity;
one or more affiliates of a said legal entity;
a credit rating of a said legal entity;
an industry area of a said legal entity;
one or more payment practices of a said legal entity;
an internal community reputation of a said legal entity pertaining to a reputation of said legal entity inside an online marketplace; and
an external community reputation of a said legal entity pertaining to a reputation of said legal entity outside an online marketplace.

11. An online sports system according to claim 8, further comprising an integrated marketing vehicle platform system, wherein any one of:
an informational content exchange between the sponsorship seller user entity and the sponsorship purchaser user entity on a first platform, and
an informational content exchange between the sponsorship seller user entity and the sponsorship purchaser user entity on a second platform occurs,
wherein each said informational content exchange comprising exchange of information of any one of the types:
demographics informational content,
psychographics informational content,
informational content related to previous responses, and
informational content specific to a brand entity, and
wherein each said type comprises informational content relating to any one of:
sports fans and aficionados;
listeners and viewers of broadcasted events; and
participants of Internet websites.

12. An online sports system according to claim 7, wherein the sports related transaction is a transaction relating to the bartering of goods, the seller user entities are goods seller user entities, and the recipient user entities are goods purchaser user entities.

13. An online sports system according to claim 12, wherein the sports related transaction relates to the purchase and sale of goods in a motorsports industry.

14. An online sports system according to claim 13, wherein the goods are used automotive parts, wherein the goods seller user entities are one of:
one or more motorsports racing teams; and
one or more agents of said motorsports racing teams, and
wherein the investigation of goods seller user entities comprises soliciting or gathering information relating to any one of:
an identity of a said motorsports racing team;
an identity of a driver driving for a said motorsports racing team;
one or more physical characteristics relating to the goods;
one or more pricing information relating to the goods;
one or more historical information relating to the goods;
an internal community reputation of a said motorsports racing team pertaining to a reputation of said motorsports racing team inside an online marketplace; and
an external community reputation of a said motorsports racing team pertaining to a reputation of said motorsports racing team outside an online marketplace.

15. An online sports system according to claim 1, wherein the sports related transaction relates to purchaser tasks, wherein the purchaser tasks comprise any one of:
soliciting criteria related to tasks from purchaser user entities; and
providing said criteria to any one of: seller user entities, and firm user entities.

16. An online sports system according to claim 1, wherein the sports related transaction relates to engagement conditions, wherein the engagement conditions comprise any one of:
online evaluation of a set of conditions between provider user entities and recipient user entities; and
agreement to said engagement conditions.

17. An online sports system according to claim 1, wherein the sports related transaction relates to online communication, wherein the online communications comprises:
permitting user entities to communicate with one another and retrieve information online via any one of: real-time chats, video, radio and message threads.

18. An online sports system according to claim 1, wherein the sports related transaction relates to fee methods, wherein the fee methods comprise any one of:
permitting the one or more user entities the ability to investigate any one of: standard billing arrangements, alternative billing arrangements, and auction billing arrangements; and
permitting any one or more of the user entities the ability to agree to terms and conditions regarding any one of said standard billing arrangements, said alternative billing arrangements, and said auction billing arrangements with any one or more of the user entities.

19. An online sports system according to claim 1, wherein the sports related transaction relates to banking, wherein the banking comprises any one of:
permitting any provider user entity the ability to be paid for services rendered to any recipient user entity; and
permitting any party the ability to receive payments through use of the online sports system through any one of:
(i) a flat fee first usage payment structure based upon usage of the online sports system;
(ii) a flat fee structure periodic payment fee structure based upon usage of the online sports system;
(iii) an escalating fee structure based upon usage of the online sports system;
(iv) a transactional fee structure based on transactions carried through the online sports system;
(v) an advertising fee structure based upon advertisement featured on the online sports system;
(vi) a sponsorship fee structure based upon sponsorship of the online sports system;
(vii) a direct marketing fee structure whereupon user entity information is sold for payments; and
(viii) a hybrid model comprising a combination of any of: (i) through (viii).

20. An online sports system according to claim 1, wherein the sports related transaction relates to progress management, wherein the progress management comprises any one of:
permitting one or more recipient user entities to determine and manage the quality and quantity of work provided by one or more provider user entities;
permitting one or more recipient user entities to evaluate the billing methods and payments of one or more provider user entities; and
permitting recipient user entities to evaluate a level of satisfaction thereof with one or more provider user entities.
